(19) United States
(12) Patent Application Publication
(10) Pub. No.: US 2025/0257891 A1
(43) Pub. Date: Aug. 14, 2025

(54) Advanced Air Quality Management System Utilizing Machine Learning and Data Fusion for Health Optimization and Energy Efficiency

(71) Applicants: Paul Bursch, McMinnville, OR (US); David Burchfield, McMinnville, OR (US); Bao Tran, Saratoga, CA (US)

(72) Inventors: Paul Bursch, McMinnville, OR (US); David Burchfield, McMinnville, OR (US); Bao Tran, Saratoga, CA (US)

(21) Appl. No.: 18/436,598

(22) Filed: Feb. 8, 2024

Related U.S. Application Data
(63) Continuation-in-part of application No. 17/717,107, filed on Apr. 10, 2022, now Pat. No. 11,934,166.

(51) Int. Cl. F24F 11/46; F24F 11/00; F24F 11/64

(52) U.S. Cl. CPC F24F 11/46; F24F 11/0001; F24F 11/64

(57) ABSTRACT

This preferred embodiment pertains to a system designed to manage and optimize indoor air quality within a certain space. It employs a processor, multiple sensors, air dampers, and highly sophisticated machine learning code to control air flow, consider energy consumption, and analyze air quality data to maintain optimal conditions for both health and energy efficiency.

The present application claims priority to application Ser. No. 17/717,107 filed Apr. 10, 2022, the content of which is incorporated by reference.

### BACKGROUND

The increasing concerns regarding indoor air quality and its impacts on human health necessitate systems which provide robust and optimized management of air flow and quality within enclosed spaces. Traditional systems for managing indoor air quality generally operate according to preset parameters and rely on static schedules or manual control, lacking the ability for dynamic adjustment based on real-time condition changes. Further, consideration of indoor environmental conditions alone do not provide a comprehensive understanding of the possible sources of pollution or health risks.

In recent times, potential sources of contamination such as pollutants, bacteria, and viruses (including SARS-COV-2 virus responsible for COVID-19) have increased the demand for improved indoor air management systems. Health organizations and government bodies constantly update and provide data concerning regional or localized pollutant levels, infection occurrences and other relevant public health parameters. However, traditional ventilation and air management systems do not have the capability to access, interpret, and apply this data for improved operation and optimized indoor air quality.

In addition, the use of air conditioning and heating equipment in residential and commercial buildings significantly impacts energy consumption. Thus, there is a need for systems that allow for improved energy efficiency alongside maintaining good air quality.

### SUMMARY OF THE INVENTION

In one aspect, a method to manage air quality in a space includes collecting air flow data, energy consumption data, and air quality data from one or more sensors in the space; performing sensor data fusion to bring together a community of data sources (government/weather, nearby/adjacent buildings, and building being managed) to trigger control system adjustments from a variety of sources to minimize energy usage; collecting environmental and public health data to calculate risk assessments and apply mitigation tactics while optimizing building occupant health and energy efficiency; and controlling air conditioning system in a closed loop to provide air quality in the space.

In another aspect, a system to manage air quality in a space includes:
a processor;
sensors to collect air flow data, energy consumption data, and air quality data in the space;
outdoor air dampers to control an outdoor air exchange rate;
a fan to control an air changes per hour (ACH);
an air damper to control an outdoor air fraction (OAF); and
code executed by the processor to:
   receive air quality data from related building zones;
   receive at one or more predetermined intervals at least one of government environmental and health data;
   calculate an indoor contamination level and an outdoor contamination level by determining the number of particulate matters at or below 2.5 microns, fan speed data, damper position data, the air quality data from the related building zones, the government data, the air flow data, the energy consumption data, and the air quality data; and
   when indoor contamination level is at or above 15 micrograms, mitigate health risk of an occupant of the space by:
   when outdoor contamination level is at or below a low threshold of 15 micrograms, increase the OAF with the air damper;
   when outdoor contamination level is above the low threshold and below a moderate threshold of 40 micrograms, decrease OAF with the air damper and linearly increase the ACH with the fan;
   when indoor contamination level exceeds the outdoor contamination level, increase the ACH with the fan and OAF with the air damper; and
   when the indoor contamination and the outdoor contamination are above a high threshold, increase the ACH with the fan and linearly decrease the OAF with the air damper.

In yet another aspect, a system to manage air quality in a space includes:
a processor;
one or more sensors coupled to the processor to collect air flow data, energy consumption data, and air quality data in the space;
one or more air dampers controlled by the processor; and
code executed by the processor to periodically receive government data and apply environmental data or public health data with the data sources to calculate risk mitigation and to optimize building occupant health and energy efficiency by controlling an air management system to provide air quality in the space and if outdoor contamination is below a threshold, increasing an outdoor air exchange rate to remove indoor contamination, and when the outdoor contamination is below a second threshold, decreasing an outdoor air fraction while increasing the an air exchange rate, if when indoor contamination exceeds outdoor contamination, increasing the outdoor air exchange rate by adjusting one or more air damper positions to increase outdoor air flow, and if when the indoor and the outdoor contaminations are above a third threshold, adjusting an air changes per hour (ACH) command to the air management system and moderating the one or more air damper positions, wherein the code fuses health or safety data from government servers, climate data from weather servers, and local building data from nearby buildings, wherein the code applies one or more learning machine ensemble.

Implementations of the system manage and optimize indoor air quality within a certain space. It employs a processor, multiple sensors, air dampers, and highly sophisticated machine learning code to control air flow, consider energy consumption, and analyze air quality data to maintain optimal conditions for both health and energy efficiency.

The system actively takes into account health data and environmental factors retrieved from government and weather servers, as well as local building data from the surrounding area. Machine learning ensembles are used to control the air management system, adjusting for thresholds in indoor or outdoor contamination and triggering appropriate responses such as increasing outdoor air exchange rate, adjusting damper positions, and controlling air changes per hour (ACH) command.

The system can also predictively manage air quality based on forecasted conditions, assess energy consumption of appliances, determine sensor placement based on airflow patterns, and is capable of adjusting its function in response to health events such as COVID. Furthermore, it offers real-time control through edge processing of the ACH with each building performing its own data fusion, and can even isolate and evacuate indoor air contaminants if necessary. As such, it provides a comprehensive, intelligent, and responsive solution for managing and maintaining indoor air quality.

Moreover, historical, geographic, and building-specific data can provide valuable insights into optimizing indoor air quality. However, traditional systems often lack the ability to access or process such data and implement derived insights for control strategy. Therefore, there is a need for a system that uses machine learning algorithms to process data from multiple sources and optimize indoor air quality, thereby mitigating health risks and improving energy efficiency.

The presented system and methods facilitate dynamic control of a space's air quality by leveraging a variety of internal and external data sources and implementing machine learning models for optimized operation. This one embodiment provides a highly adaptive solution for managing indoor ventilation, which has become increasingly relevant given the recent public health concerns around airborne diseases.

### BRIEF DESCRIPTION OF DRAWINGS

FIGS. 1A-1H show an exemplary air management system.

FIG. 2 shows an exemplary Alg. 5.1—Flow Diagram to Maintain/implement the correct relative pressure in each space.

FIG. 3 shows an exemplary Alg. 5.1—Local Control Diagram.

FIG. 4 shows an exemplary Alg. 5.1—Supervisory Control Flow Diagram

FIG. 5 shows an exemplary Alg. 5.2—L Flow Diagram to Adjust Outdoor Air Fraction (OAF) and ACH based on Outdoor and Indoor air contaminants.

FIG. 6 shows an exemplary Alg. 5.2—Priority Table (System Flag Method)

FIG. 7 shows an exemplary Alg. 5.2—Priority Table (If-then-else Method)

FIG. 8 shows an exemplary Alg 5.3—L Flow Chart to Adjust flow and ACH based on current occupants and current public health risks.

FIG. 9 shows an exemplary Alg 5.3—S Flow Chart

FIG. 10 shows an exemplary Alg. 5.4—S Flow Diagram to Isolate and evacuate indoor air contaminants based on indoor IAQ sensors.

FIG. 11-12 shows exemplary Alg. 5.5—S Flow Diagrams to Respond to a public health crisis or a catastrophic event.

FIGS. 13-14 shows more details one implementation of the air management system.

FIG. 15 shows exemplary AI networks to perform air management.

### DETAILED DESCRIPTION OF THE PREFERRED EMBODIMENT

The described preferred embodiment encompasses a system that offers comprehensive management of air quality within a specified space. The components of the system consist of a processor, one or more sensors, and one or more air dampers. The processor supervises the operations of the entire system along with data collected from the sensors and influences the function of the dampers.

One embodiment provides a comprehensive solution for managing air quality in a space, leveraging a combination of hardware components, data collection, and advanced computational techniques. The system includes a processor, sensors, outdoor air dampers, a fan, and an air damper. The sensors collect data on air flow, energy consumption, and air quality within the space. The outdoor air dampers and the fan control the outdoor air exchange rate and air changes per hour (ACH), respectively. The air damper controls the outdoor air fraction (OAF).

The system's software component includes codes executed by the processor to manage and optimize air quality. These codes integrate data from various sources, including adjacent buildings, government data, and a network-wide array of sources. The data is processed using advanced data fusion and machine learning techniques. The system employs AI and machine learning algorithms, including Hidden Markov Models and neural networks, to enhance the calculation process by analyzing and interpreting this vast array of data for predictive assessments.

The system calculates indoor and outdoor contamination levels using the collected data. Based on these calculations, the system adjusts the OAF and ACH to mitigate the health risk of occupants in the space. For instance, when the outdoor contamination level is below a low threshold, the system increases the OAF. When the outdoor contamination level is above the low threshold and below a moderate threshold, the system decreases the OAF while increasing the ACH. If the indoor contamination level exceeds the outdoor contamination level, the system decreases the OAF and inversely increases the ACH. When both indoor and outdoor contamination levels are above a high threshold, the system increases the ACH and decreases the OAF.

The system also utilizes real-time analysis of both local and network-wide air quality data to dynamically adjust HVAC settings, optimizing indoor air quality based on a sophisticated understanding of environmental conditions.

An AI-enhanced decision-making algorithm dictates the HVAC system's response, ensuring actions are based on a comprehensive, AI-enhanced understanding of both local and broader air quality situations. AI can be used to predict air pollution at a local level. For instance, engineers at Cornell University have developed a simplified model that uses AI to provide a detailed view of air pollution at street level. The model combines traffic data, topology, and meteorology in an AI algorithm to learn simulations for traffic-related air pollution. For example, a hybrid model using a multilayer perception can predict air quality, and the adjustment of kernel scales with a support vector machine allows for an accurate classification of air quality.

Data fusion techniques can also be applied to improve air quality forecasts. These techniques allow for the computing of reanalyzed spatial concentration fields. Data fusion is important as it presents air quality spatial variation between real atmosphere and modeling results. AI can also collect sensor and satellite data and help in climate model blending. It can accurately find patterns in data sets for better analysis and provide tools to monitor air pollution in real-time. AI technology can discover sources of air pollution quickly and accurately.

In summary, the AI in the system for managing air quality can be implemented through predictive models, machine learning algorithms, data fusion techniques, and real-time monitoring tools. These AI implementations can help in accurately measuring and predicting air pollution, classifying air quality, and discovering sources of air pollution.

The implementation of artificial intelligence (AI) in managing air quality in a building can be enhanced by using data from adjacent buildings. This approach can help refine computations and improve the air quality in the building being managed. One way to use data from adjacent buildings is to monitor and compare air quality indicators. For instance, if an adjacent building has a significantly better air quality index (AQI), the system can evaluate their ventilation methods, the type of air filters used, or their maintenance schedules. The insights gained can then be applied to improve the air quality in the building being managed.

Another approach is to use data from adjacent buildings to understand the impact of external factors on indoor air quality. For example, if several buildings in the same area are experiencing poor air quality, it might indicate a common external factor, such as outdoor air pollution or a nearby source of contaminants. In such cases, the AI system could adjust the outdoor air exchange rate or activate air purifiers to mitigate the impact of these external factors.

Another example of how data from an adjacent building is used is in the case of a building undergoing construction or renovation. Construction activities can significantly impact indoor air quality due to the release of dust and other pollutants. If an adjacent building is undergoing such activities, the AI system in the building being managed can use this information to increase filtration or ventilation rates to counteract the increased level of pollutants.

In all these examples, the AI system accesses real-time air quality data from adjacent buildings. This could be achieved through a network of smart sensors that continuously monitor and share air quality data. The AI system could then use machine learning algorithms to analyze this data and make informed decisions to improve air quality.

The term “adjacent building” refers to a building that is near or next to another building. The proximity can be such that the buildings are touching or separated by a small distance. The term is often used in the context of property insurance policies, real estate, and urban planning. In one embodiment, “adjacent” refers to that which adjoins, and adjacent buildings are those that are touching or very close to the building being modeled or considered. These buildings can modify the boundary conditions relative to the building being considered. Thus, if one building is adjacent to another, the two buildings are next to each other and are lying near, close, or contiguous; neighboring; bordering on. The adjacent building refers to a building that is near or next to the building whose air quality is being managed. Data from such buildings can be used to refine computations and improve the air quality in the building being managed. Building sensors are designed to collect comprehensive data within a particular space, or within sub-spaces in the buildings. This data includes air flow quantities, energy consumption, and elements that determine the quality of air. These sensors are directly linked with the processor, hence, any changes detected within the space are recorded and relayed to the processor for further appropriate action concerning space air regulation.

Data fusion is a process that integrates information from multiple data sources to provide a more comprehensive understanding of a subject or phenomenon. In the context of building management, data fusion can be used to gather and analyze data from a variety of sources, including government agencies, adjacent buildings, and sensors within the building itself. In one embodiment, the following data sources undergo data fusion and then analyzed:
a. Government Data Sources: Government agencies like the Environmental Protection Agency (EPA) and weather channels provide valuable data that can be used in building management. For instance, the EPA's EQUATES project offers meteorology, emissions, and air quality modeling datasets that can be used to understand and predict air quality trends Weather channel data can be used to anticipate weather conditions that might affect the building's heating, cooling, and ventilation needs.
b. Adjacent Buildings: Data from adjacent buildings can be used to understand local environmental conditions and trends. For example, air quality data from nearby buildings can be used to predict air quality in the building being managed. This can be particularly useful in urban areas where buildings are closely packed together.
c. In-Building Sensors: Sensors within the building can provide real-time data on a variety of factors, including indoor air quality, temperature, humidity, and energy use. This data can be fused with data from external sources to provide a comprehensive picture of the building's environment. For example, a study on indoor air quality monitoring used multisensor fusion of air pollutant data to improve the accuracy of indoor air quality assessments.

Air quality data is collected and analyzed in air quality management systems through a combination of monitoring, data validation, statistical analysis, and active air management/reporting:

Data Collection: Air quality data is collected through monitoring stations that measure various pollutants in the air, such as particulate matter, ozone, nitrogen dioxide, sulfur dioxide, carbon monoxide, and volatile organic compounds. The Air Quality System (AQS), a repository of the U.S. Environmental Protection Agency (EPA), stores data from over 10,000 monitors, 5,000 of which are currently active. This system contains ambient air pollution data collected by EPA, state, local, and tribal air pollution control agencies. The data is then fused with IAQ sensors in adjacent buildings as well as in the building being managed. Data fusion is a process that integrates information from multiple data sources to provide a more comprehensive understanding of a subject or phenomenon. In the context of air quality management, data fusion can be used to gather and analyze data from a variety of sources, such as government agencies, adjacent buildings, and sensors within the building itself. Here is an example of how data fusion can be performed using Python and the Pandas library:

import pandas as pd
# Load data from different sources
df1 = pd.read_csv(‘data_source_1’)
df2 = pd.read_csv(‘data_source_2’)
df3 = pd.read_csv(‘data_source_3.’)
# Ensure that the data is in the same format
df1[‘timestamp’] = pd.to_datetime(df1[‘timestamp’])
df2[‘timestamp’] = pd.to_datetime(df2[‘timestamp’])
df3[‘timestamp’] = pd.to_datetime(df3[‘timestamp’])
# Merge the dataframes on the timestamp column
df = pd.merge(df1, df2, on=‘timestamp’, how=‘outer’)
df = pd.merge(df, df3, on=‘timestamp’, how=‘outer’)
# Interpolate missing values
df = df.interpolate(method=‘time’)
# Now df contains the fused data
ControlAirFlow(df)

In this example, we assume that each data source is a streaming data from government/weather, adjacent buildings, and current building with a timestamp column. The data from each source is loaded into a separate DataFrame. The timestamp column is converted to datetime format to enable time-based operations. The DataFrames are then merged on the timestamp column using an outer join, which includes all timestamps from all sources. Finally, any missing values resulting from the merge are interpolated based on time.

Data Validation: Before analyzing the data, it is crucial to ensure its reliability and accuracy. This is achieved through a process called data validation, which involves checking and correcting any errors, gaps, outliers, or inconsistencies in the data. Various techniques and criteria are used for data validation, such as quality assurance and quality control protocols, data completeness and representativeness, data screening and flagging, and data correction and interpolation.

Data Analysis: Once the data is validated, it is analyzed to understand the trends, patterns, sources, and effects of air pollution. This analysis can be performed using various methods and tools. For instance, the openair package in R provides many functions for air quality data analysis. The Center for Air Quality at Ohio University has conducted various statistical analyses including compliance analysis, significance tests, regression analysis, time series analysis, spatial analysis, and factor analysis.

Active control of airflow in the building being managed and Data Reporting: The analysis is used for active control of airflow in the building being managed, for example by increasing or decreasing airflow as detailed below. The final step in the process is data reporting, which involves presenting and communicating the results of the data analysis to stakeholders such as researchers, policymakers, or the public. This can be done through various formats and media such as reports, papers, presentations, posters, or infographics.

Data fusion can also be used to create predictive models. For instance, a study on spatial modeling of air pollution used data fusion to create a model of air pollution in an industrial facility and a large city. Another study used data fusion to estimate high-resolution urban heatwave air temperatures.

In all these cases, data fusion provides a more comprehensive and accurate understanding of the building's environment, which can be used to make more informed management decisions.

Data from weather channels can be used in air quality management systems in several ways. Here are some detailed examples:

Predicting Air Quality: Weather data can be used to predict air quality trends. For instance, weather conditions such as temperature, wind speed, and direction can influence the dispersion and concentration of pollutants. High temperatures and sunlight can also lead to the formation of ground-level ozone, a harmful air pollutant. By monitoring weather data, an air quality management system can anticipate these trends and take appropriate action.

Adjusting Ventilation Systems: Weather data can be used to optimize the operation of a building's ventilation system. For example, if the weather channel predicts high levels of outdoor air pollution, the air quality management system can reduce the outdoor air exchange rate to minimize the intake of polluted air. Conversely, if the outdoor air quality is good, the system can increase the outdoor air exchange rate to bring in fresh air and improve indoor air quality.

Emergency Response: Weather data can be used to respond to emergencies that can impact air quality. For instance, if the weather channel reports a nearby wildfire, the air quality management system can activate air purifiers or increase filtration rates to protect indoor air quality.

Data Fusion: Weather data can be combined with other data sources to provide a more comprehensive understanding of air quality. For instance, a study in Bucharest used data from atmospheric stations, which included meteorological data, to create reports for every air pollutant. This data was then processed using machine learning to combat pollution in big cities.

In all these examples, the air quality management system would need to have access to real-time weather data. This could be achieved through an API or data feed from the weather channel. The system could then use algorithms to analyze this data and make informed decisions to manage air quality. The buildings can use one or more air dampers. Functionally, these air dampers can be manipulated by the processor, hence, they can be used for achieving the desired air quality within the space. By carefully controlling these dampers, the system is able to effectively manage the air content, direction, and intensity within the space.

The system incorporates an executing code, the responsibility of which lies in the ongoing receipt of government data and subsequent application of environmental and public health data against the collected data sources. This combination works to calculate potential risk mitigation strategies while also trying to optimize the health of the building occupants. It ensures the feasibility of energy efficiency by controlling the air management system carefully to provide the required air quality.

The system functions by interacting actively with the external environment. In a situation where outdoor contamination is below a preset threshold, the system works to increase the outdoor air exchange rate, effectively removing indoor contamination. Contrarily, when outdoor contamination drops beneath a second threshold, the system modifies to decrease the outdoor air fraction, coupled with an increased air exchange rate.

In scenarios where indoor contamination exceeds that of the outdoors, the system adjusts for this by increasing the outdoor air exchange rate and adjusting the positions of the air dampers to encourage a maximal inflow of outdoor air. However, if the indoor and outdoor contaminations are jointly above a third threshold, the system responds by adjusting the number of air changes per hour command to the air management system and manipulating the damper positions accordingly.

The executing code further illustrates the system's proactive approach to safety. It fuses health or safety data from government servers, climate data from weather servers, and local building data from nearby buildings. The code applies a learning machine ensemble to interpret and react to this data, ensuring the continuous adaptation of the system to changing parameters for optimized air quality control.

Air quality is a critical concern for urban environments, impacting the health and well-being of inhabitants. Traditional methods of air quality control often rely on isolated sensors and limited data sources. In this whitepaper, we propose a comprehensive data fusion approach to air quality control, which integrates data from government servers, nearby building sources, and weather servers. The system utilizes machine learning ensembles to predict and moderate air damper positions, with the primary objective of enhancing the overall air quality, while also ensuring health and safety.

Air quality management has become increasingly vital in modern urban environments, as pollution levels, and their detrimental effects on public health, continue to rise. To address this issue effectively, a holistic approach is needed, which incorporates data from various sources. This whitepaper outlines a novel method for air quality control, which leverages data fusion techniques to optimize air damper positions based on the combined information from government data, nearby buildings, and climate data.

The fusion of diverse Data Sources is detailed next. The data includes Government Data. Government agencies typically monitor air quality through a network of sensors and provide data on pollutant levels and regulatory standards. This source offers the foundational data for our system. It includes real-time pollutant concentrations, air quality indices, and safety guidelines. The data also includes Neighboring/Adjacent Building Data. Neighboring buildings can significantly impact local air quality. Neighboring buildings refer to structures that are situated in close proximity to each other, typically sharing a common boundary or being located in the immediate vicinity of one another. These buildings may share physical boundaries such as walls, fences, or property lines, and they are often part of the same local area or community. The term is commonly used in urban and suburban contexts to describe the spatial relationships between structures within a neighborhood or city block. As detailed herein, the proximity of neighboring buildings can influence various aspects of neighborhood air quality, energy management, health management, and community development. Information from these sources can include data on HVAC system operations, occupancy patterns, and pollutant emission levels. By integrating this information, the system can make adjustments to air damper positions, ensuring the building's contribution to local air quality is optimized. The data can include Weather/Climate Data. Weather and climate conditions play a critical role in air quality. Weather servers provide data on wind speed, wind direction, temperature, humidity, and precipitation, which can help predict pollutant dispersion patterns. These variables impact how pollutants disperse and accumulate in the atmosphere, and thus, the system can adjust air damper positions accordingly. In one embodiment, API code enables automatic data downloads from these diverse data sources to supplement the current building data in making a comprehensive decision.

Data fusion can be broadly defined as the process of integrating and combining data from multiple sources, including ground-based monitoring stations, remote sensors, satellite observations, weather data, and various other sources, to create a comprehensive and more accurate representation of air quality conditions. This approach allows environmental authorities, researchers, and policymakers to obtain a holistic view of air quality, improving their ability to monitor, analyze, and make informed decisions related to air quality management. Data fusion aims to provide a more robust and detailed understanding of pollution levels, sources, and trends, ultimately contributing to more effective strategies for mitigating air pollution and safeguarding public health and the environment.

The system employs data integration techniques, including machine learning ensembles, to merge data from these diverse sources. This process is essential for creating a comprehensive understanding of the local air quality situation. The system's algorithm combines the data points and identifies correlations and dependencies between them. Machine learning ensembles are applied to learn and predict optimal air damper positions. By considering the complex interplay of government data, building data, and climate data, the system can make dynamic decisions. Ensembles of machine learning models, such as decision trees, neural networks, and support vector machines, collectively provide a more robust and accurate predictive model.

Control Mechanism is detailed next. The integrated system actively moderates air damper positions to improve local air quality. The following steps outline the control mechanism:
Data Collection: Government data, building data, and climate data are continuously collected in real-time.
Data Fusion: The collected data is fused into a unified dataset using machine learning ensembles.
Prediction: Machine learning models predict the impact of various damper positions on air quality based on the fused data.
Optimization: The system optimizes air damper positions based on the predicted impact, considering government safety guidelines, building occupancy, and weather conditions.
Feedback Loop: The system uses feedback mechanisms to continually adjust air damper positions, ensuring that air quality remains within acceptable limits.
Implementing this integrated air quality control system offers several benefits:
Improved Air Quality: The system aims to significantly enhance local air quality, reducing the health risks associated with poor air quality.
Energy Efficiency: By optimizing air damper positions, energy consumption is reduced, leading to cost savings and a smaller environmental footprint.
Safety Compliance: The system ensures that air quality remains within government safety guidelines, reducing regulatory risks.

The data fusion approach to air quality control represents a cutting-edge solution for urban environments. By integrating government data, building data, and climate data and employing machine learning ensembles, the system optimizes air damper positions, thereby improving air quality and enhancing public health and safety. This approach represents a significant step toward sustainable and efficient air quality management in urban settings.

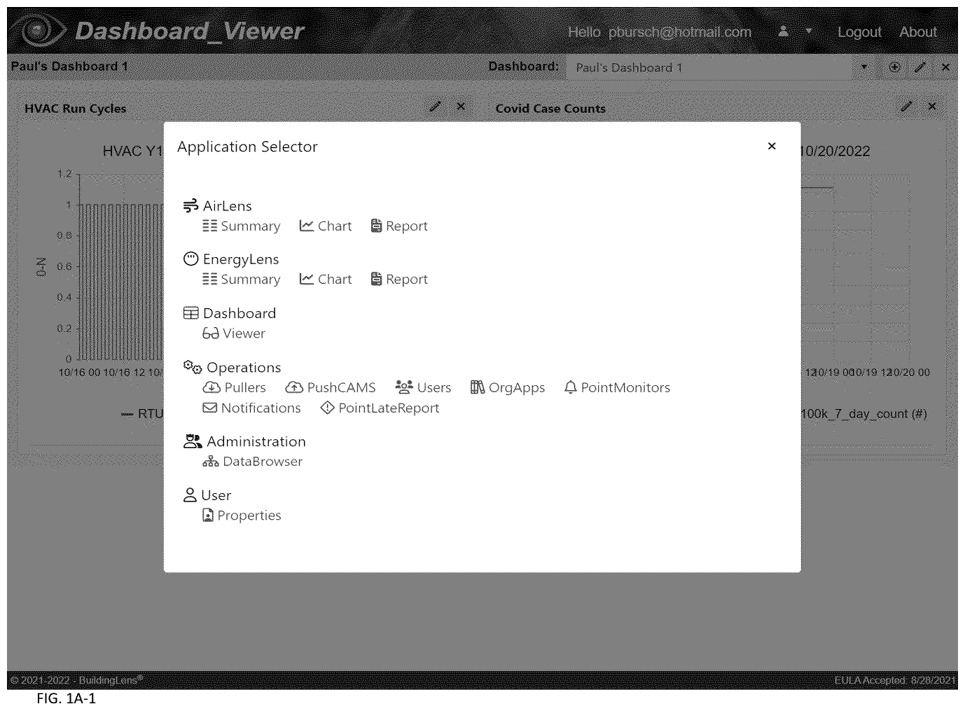

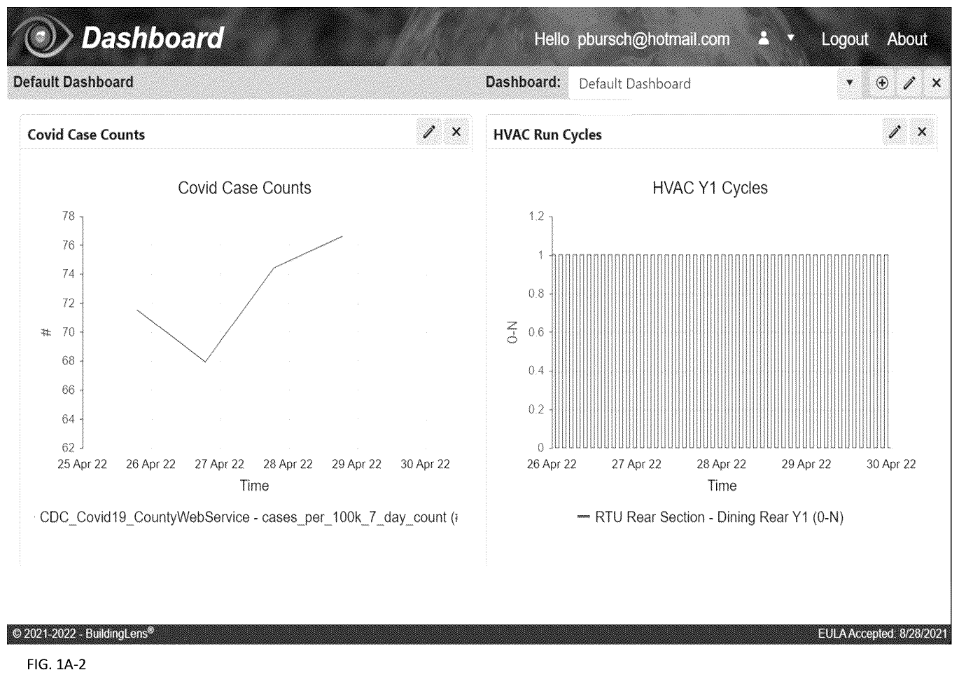

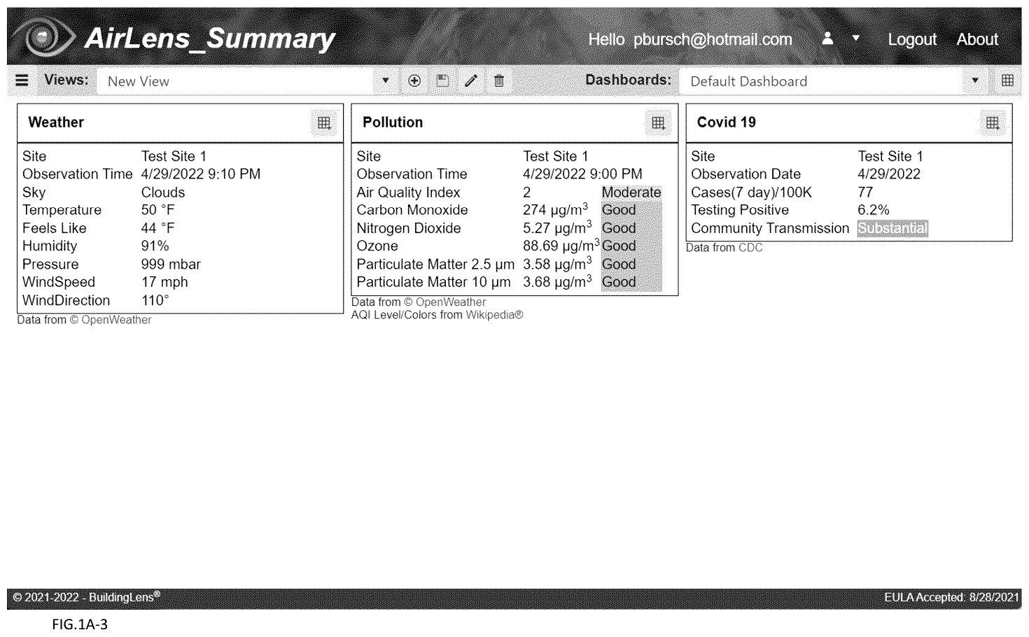

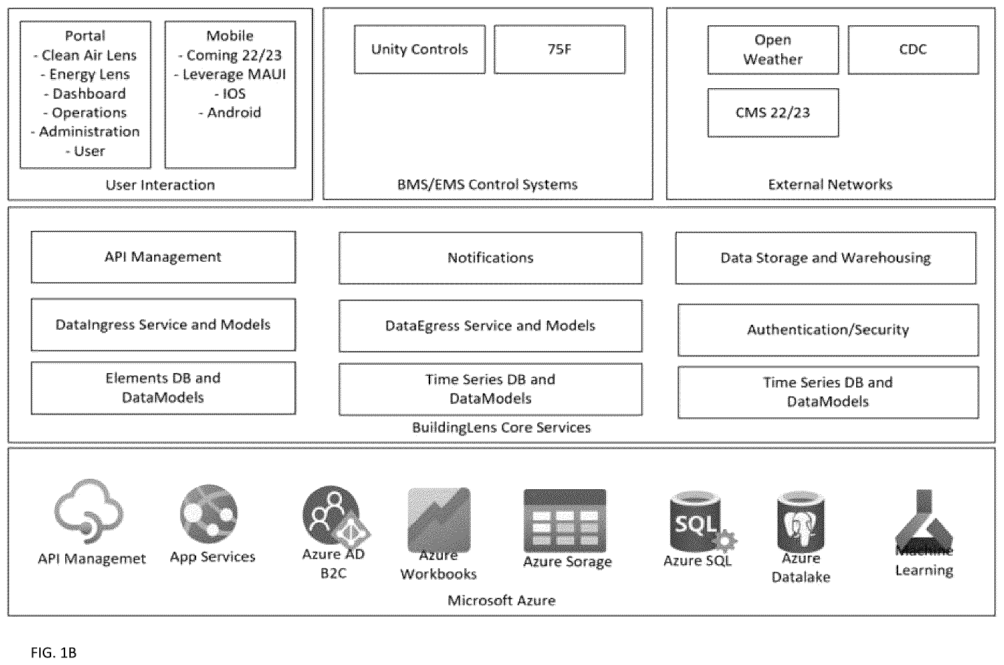

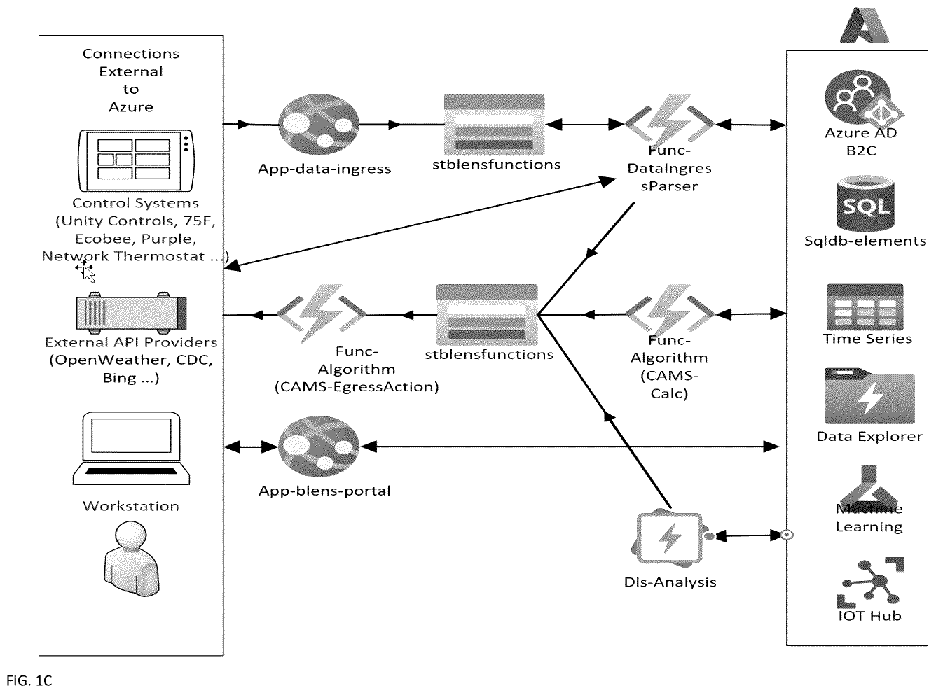

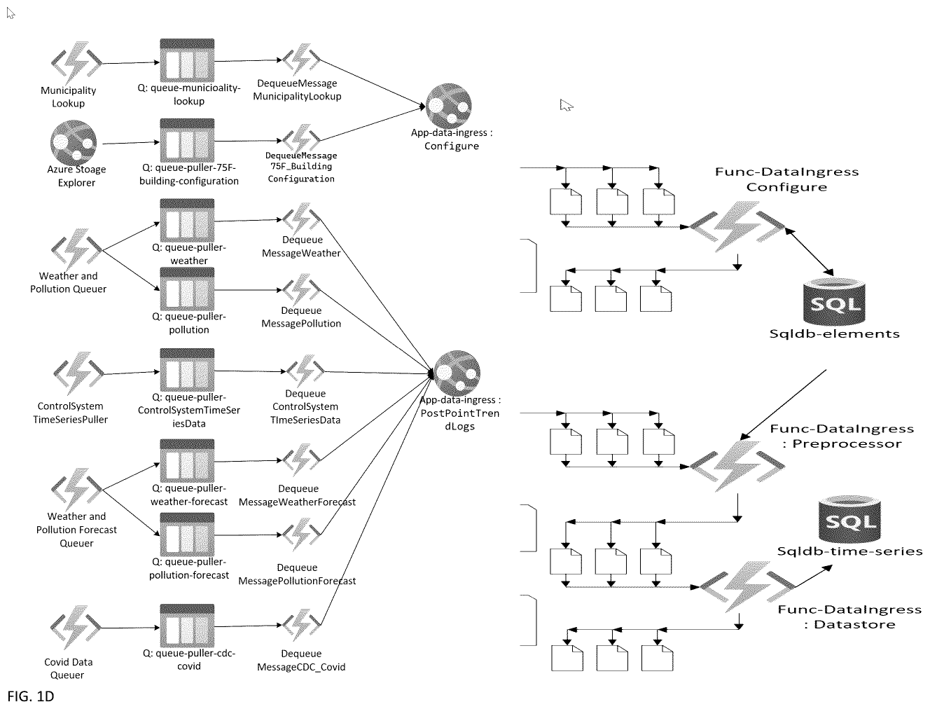

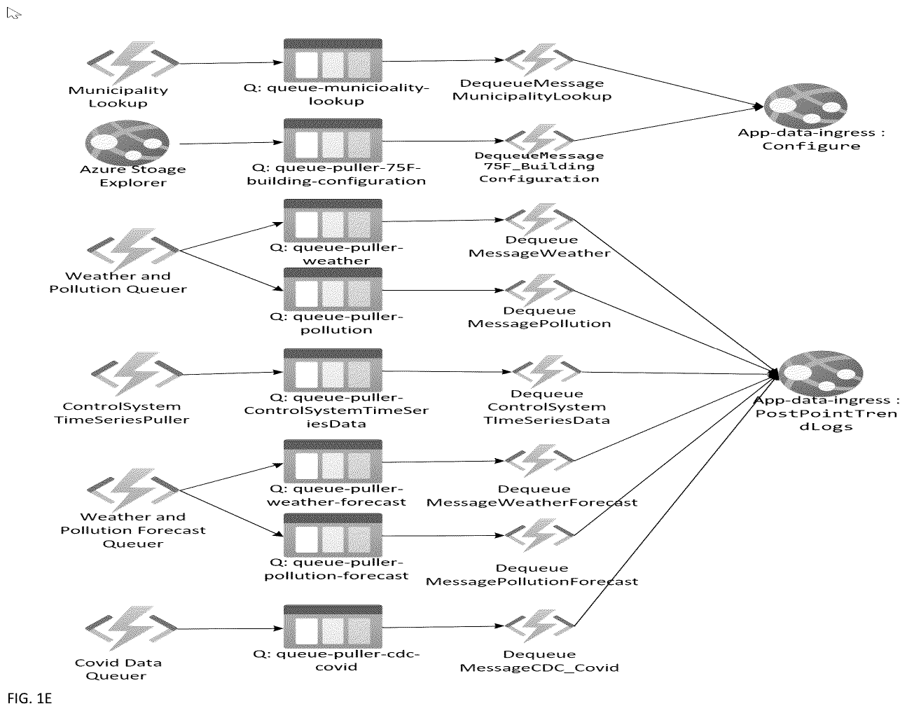

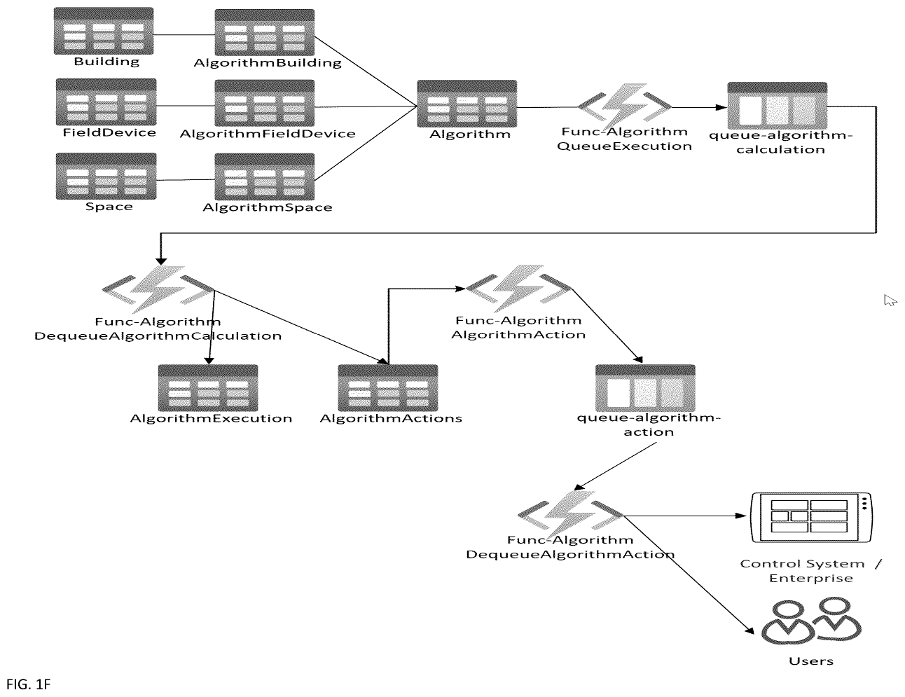

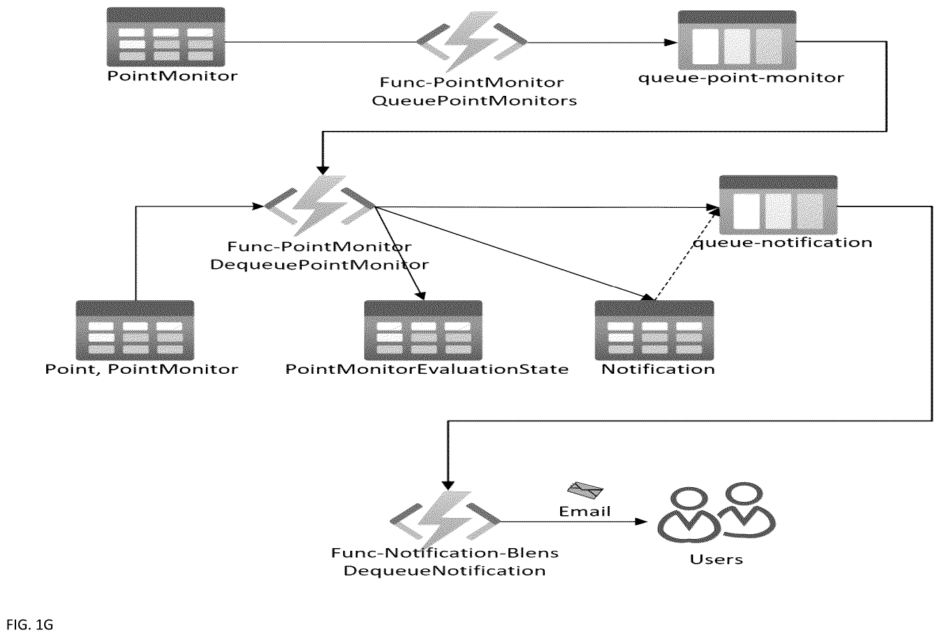

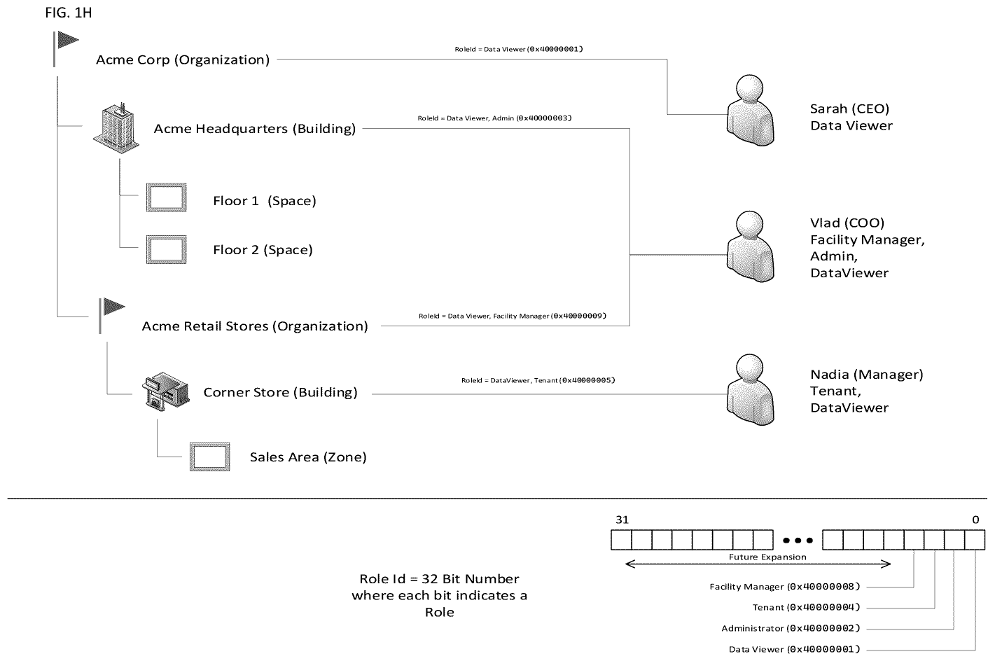

FIGS. 1A-1H show an exemplary air management system. The system includes sensors and software that monitor airflow patterns typical in small commercial buildings using Computational Fluid Dynamics (CFD) and indoor air contaminants' health effect on people in various building types by identifying consensus positions. The model of airflow patterns using CFD for typical ventilation systems can be used to inform proper placement of IAQ sensors. The online software platform analyzes buildings to determine both their energy and IAQ baselines. The research, software, and building information are integrated, and automatic building control algorithms are implemented, delivering the best possible IAQ while considering the people in the building and energy use effects. This platform will be easily integrated with any Web-Based Building Management System (BMS), making IAQ information readily available to any user. The application of this turnkey solution gives actionable information to facility managers and clearly defines the nexus between energy efficiency and healthy indoor air. The system can be deployed at government institutions, commercial portfolios, and individual buildings.

In the following discussions, the following terms/abbreviations are used:

| | |
|---|---|
| ACH | Air Change per Hour |
| CAMS | Clean Air Management System |
| CFD | Computational Fluid Dynamics |
| CO2 | Carbon Dioxide |
| HVAC | Heating, Ventilation, and Air Conditioning |
| IAQ | Indoor Air Quality |
| inWC | Inches Water Column |
| OAF | Outside Air Fraction |
| PM | Particulate Matter |

The operation includes the following steps:
collecting air flow data, energy consumption data, and air quality data from one or more sensors in the space;
performing sensor data fusion to bring together a community of data sources to trigger control system adjustments from a variety of sources to minimize energy usage;
collecting environmental and public health data to calculate risk assessments and apply mitigation tactics while optimizing building occupant health and energy efficiency; and
controlling air conditioning system in a closed loop to provide the predetermined air quality in the space.

The system includes a software Suite of tools for Building data monitoring, analysis and control. The Cloud Software Suite of Applications (SuperApp) Providing Intelligent Tools for Buildings Services. It Integrates Smart Building Systems (Building Service Providers) Providing Monitoring, Analytic and Supervisory services.

```
The system provides
      Digital Twins for Smart Building Systems:
      Bridges (Data Ingress, Data Egress, Subscriptions) - Retinas
      Application to Reason about Building Information - Lens
      Long Term Storage of Information (Big Data)
      100% cloud hosted using modern web / mobile languages and frameworks
      Secure authentication / authorization framework
      Expansion Capabilities
            Data Warehousing
            Analytic Processing Services (AI, Custom Algorithms ...)
            User Interface Applications (web/mobile)
            Dashboarding
One implementation provides Azure Functions
> Azure Functions
    • Serverless compute
    • Object Oriented
        • Database Definitions
        • Evaluation
            • Timers
            • Events
        • Json State
            • Inputs
            • Internals
            • Outputs
    • Output Action Messages
        • Email
        • Retina Delivery to Building Smart Systems
• CAMS Executive 5.6
    • Isolate and Evacuate Indoor Air Contaminants 5.4
    • Maintain Correct Relative Pressure 5.1
    • Adjust Outdoor Air Fraction (OAF) and Air Changes per Hour (ACG) 5.2
    • Adjust ACH based on Zone Occupants and Public Health Risks (5.3)
    • Respond to Public Health Crisis or Catastrphic Events (5.5)
    • Safe Air Space Evaluator (5.7)
    • Generate Health Alerts (5.8)
Data Monitor Definitions / User
    • Monitor Types
        • Greater Than
        • Less Than
        • In Band (Coming Soon)
        • Not In Band (Coming Soon)
        • Equal To
        • Not Equal To
    • Point Types
        • Analog
        • Discrete
    • Time In Alarm State
        • Expressed In Milliseconds
    • Notification
        • Email
        • Frequency Limit In Minutes
Roles
    • Actor (user)
        • Mapped to one or more
            • Organization
            • Building
            • Space
        • Mapping bit pattern determines roles
            • Data Viewer (0x40000001)
            • Administrator (0x40000002)
            • Tenant (0x40000004)
            • Facility Manager (0x40000008)
Data Monitor Definitions / User
    • Monitor Types
        • Greater Than
        • Less Than
        • In Band (Coming Soon)
        • Not In Band (Coming Soon)
        • Equal To
        • Not Equal To
    • Point Types
        • Analog
        • Discrete
    • Time In Alarm State
        • Expressed In Milliseconds
    • Notification
        • Email
        • Frequency Limit In Minutes
Roles
    • Actor (user)
        • Mapped to one or more
            • Organization
            • Building
            • Space
        • Mapping bit pattern determines roles
            • Data Viewer (0x40000001)
            • Administrator (0x40000002)
            • Tenant (0x40000004)
            • Facility Manager (0x40000008)
One embodiment uses Augmented Reality to Provide
    • Conduct Building Site Survey Linking Field Technicians With Central Office Experts
    • Headset AI to automatically determine site components of interest
    • Automated Headset Spatial Sensors to Automatically Determine Space Geometry
    • Junior Site Survey Engineers remote monitoring
```

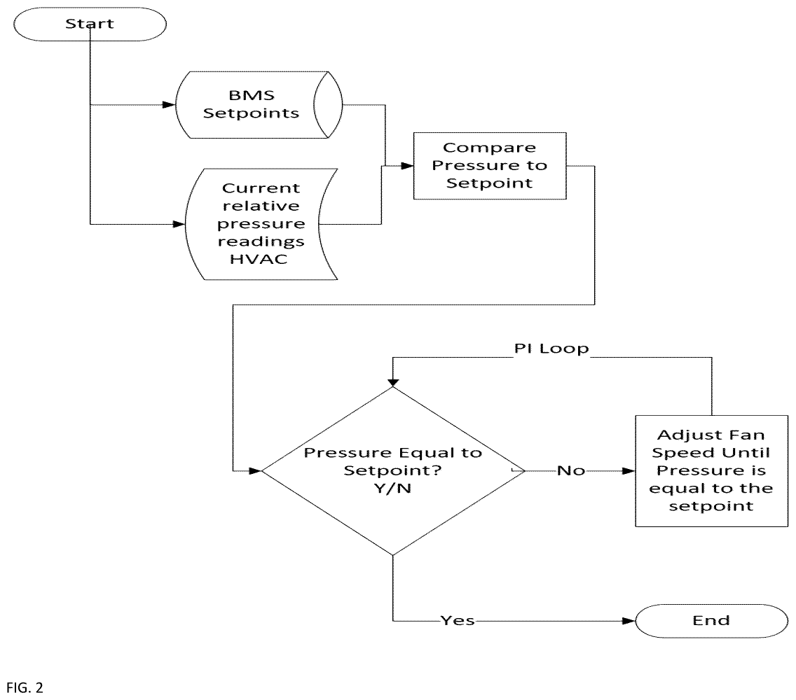

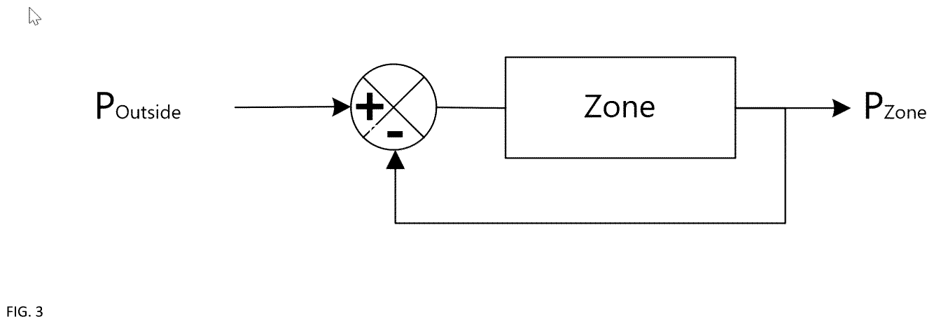

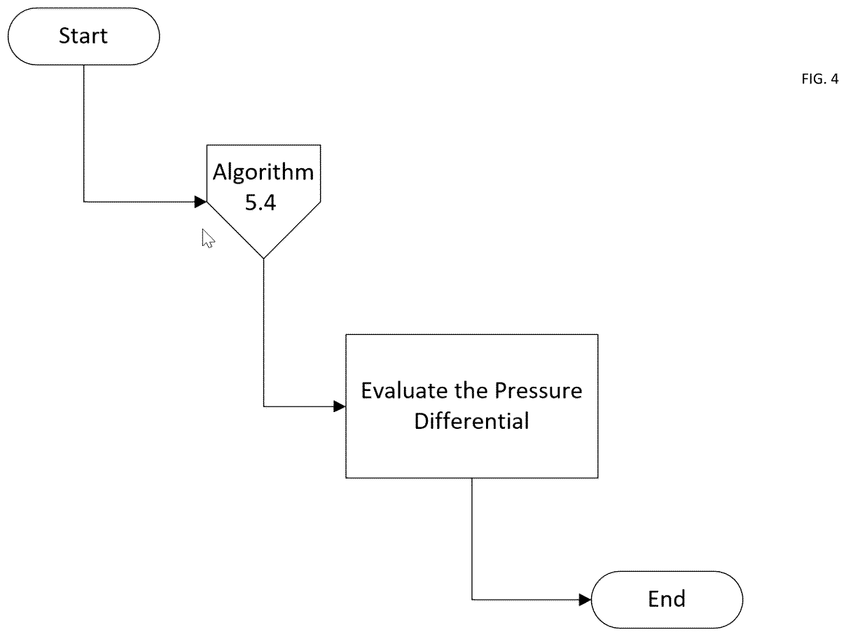

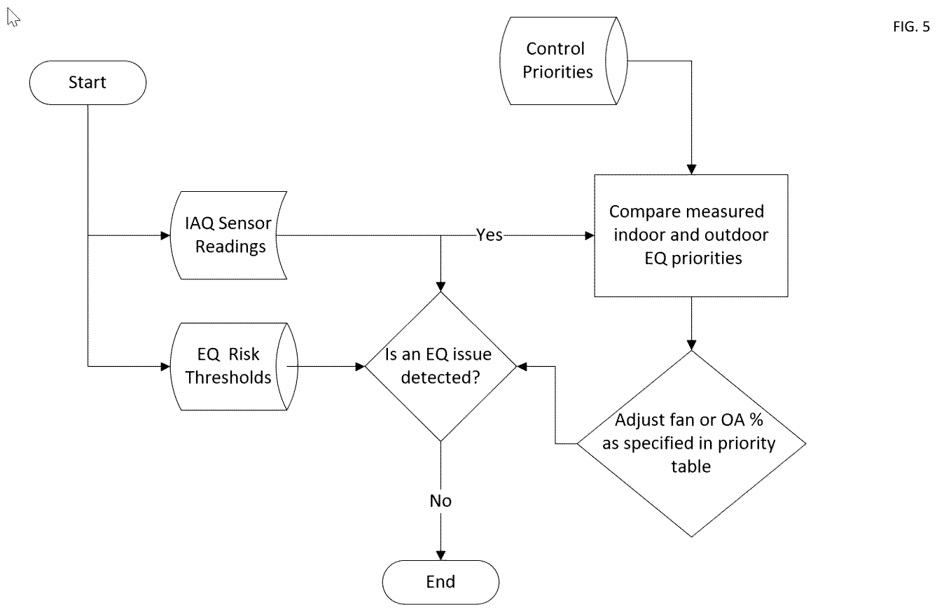

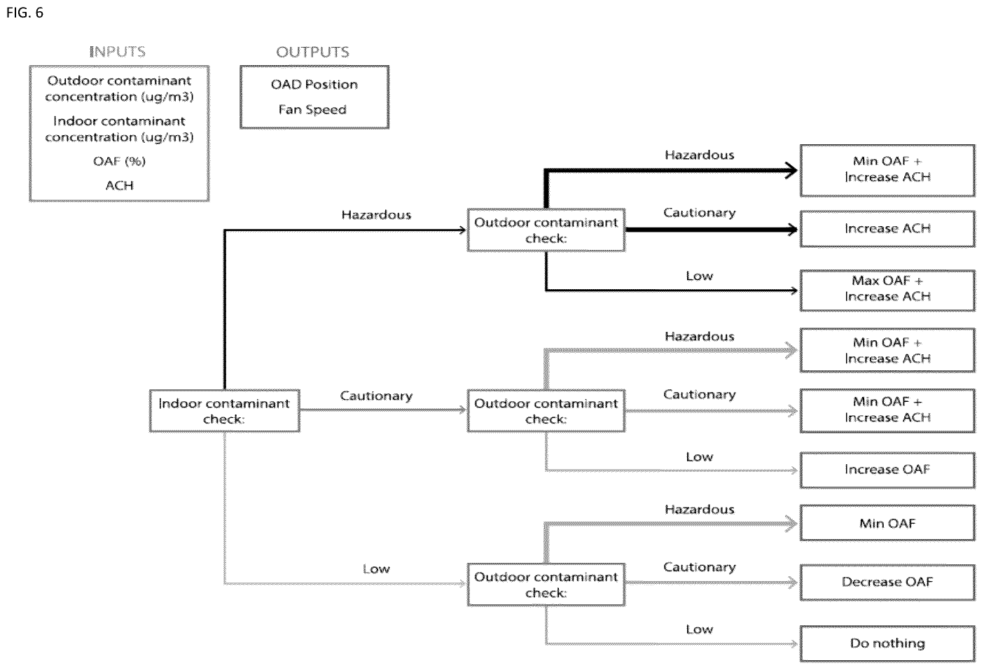

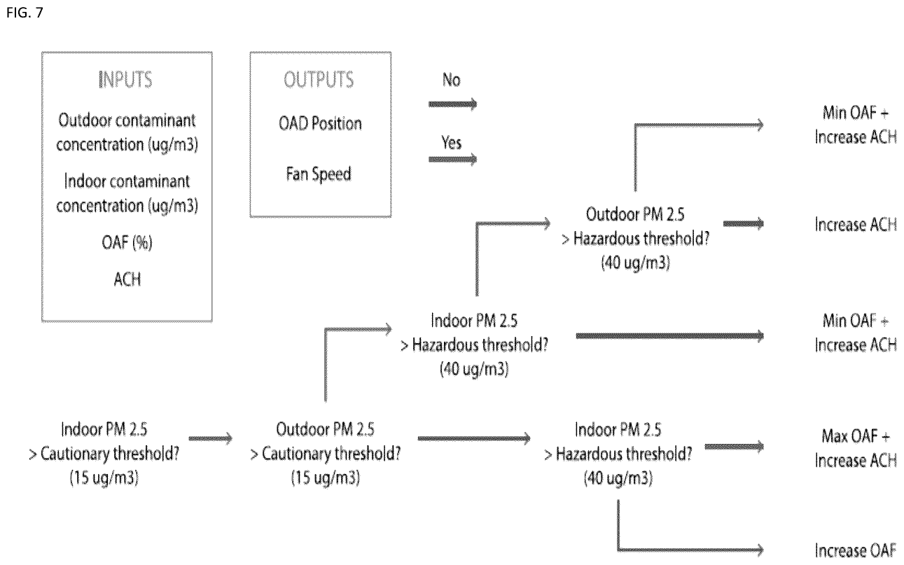

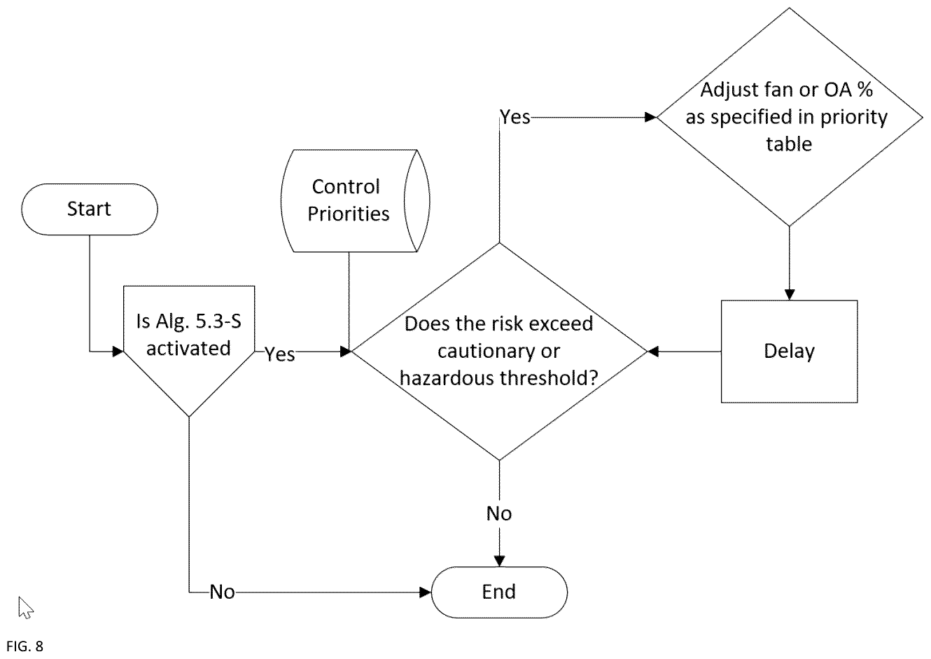

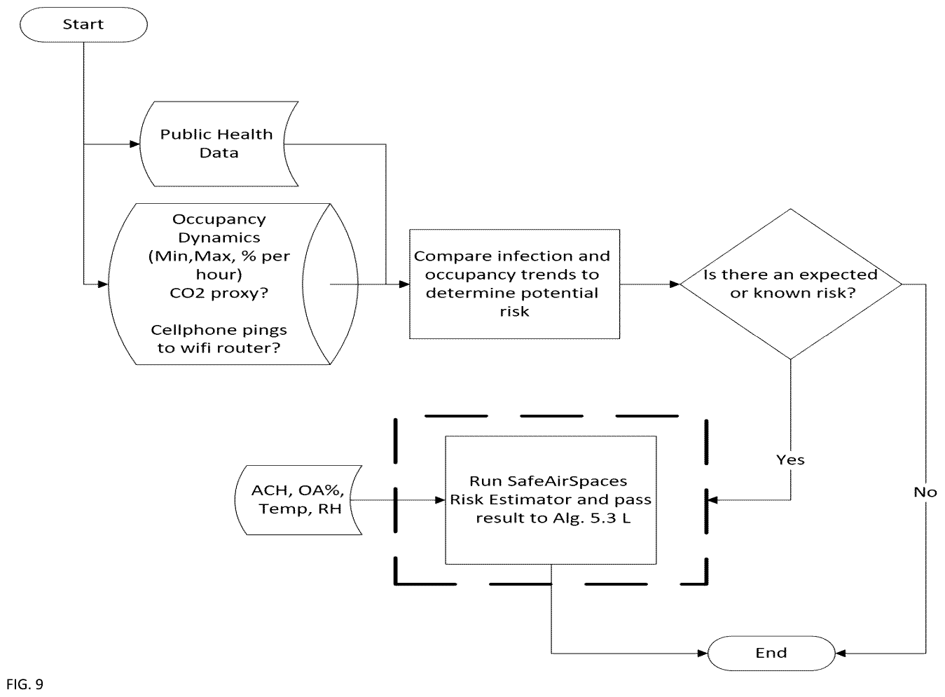

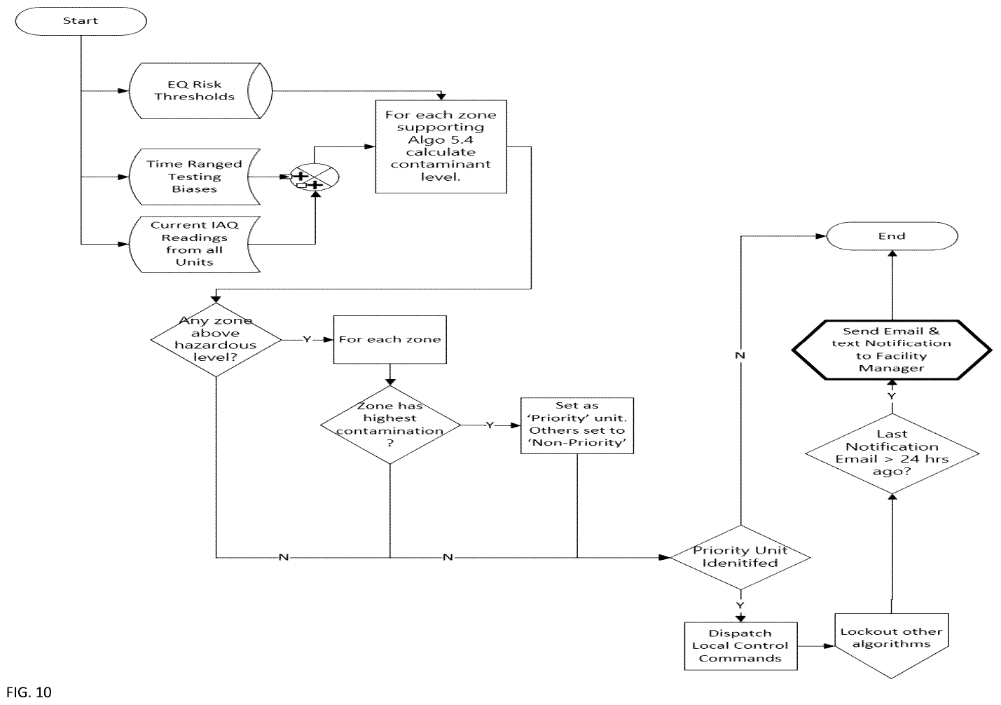

Next, the processes run by the system of FIGS. 1A-1H are detailed. FIG. 2 shows an exemplary Alg. 5.1 Flow Diagram to Maintain/implement the correct relative pressure in each space. FIG. 3 shows an exemplary Alg. 5.1 Local Control Diagram. FIG. 4 shows an exemplary Alg. 5.1 Supervisory Control Flow Diagram. FIG. 5 shows an exemplary Alg. 5.2-L Flow Diagram to Adjust Outdoor Air Fraction (OAF) and ACH based on Outdoor and Indoor air contaminants. FIG. 6 shows an exemplary Alg. 5.2-Priority Table (System Flag Method). FIG. 7 shows an exemplary Alg. 5.2 Priority Table (If-then-else Method). FIG. 8 shows an exemplary Alg 5.3-L Flow Chart to Adjust flow and ACH based on current occupants and current public health risks. FIG. 9 shows an exemplary Alg 5.3—S Flow Chart. FIG. 10 shows an exemplary Alg. 5.4—S Flow Diagram to Isolate and evacuate indoor air contaminants based on indoor IAQ sensors.

```
Algorithm 5.1: Maintain/implement the correct
relative pressure in each space
Name: CAMS_Zone_RelativePressure_5_1
Applicability:
    • HVAC Zones where occupancy type is not kitchen
Local Control
Local controls balance the indoor zone pressure against
the outside air pressure.
Assumptions & Requirements
    • This algorithm applies to all zones.
    • Kitchens are exceptions
```

In FIG. 3, the algorithm evaluates each zone's pressure relative to the pressure observed outside the building and compares the zone pressures to the relative pressure setpoints. If the zone pressures are not equal to the zone pressure setpoints, fan speeds of the HVAC units serving the zone will be adjusted to maintain the correct relative pressure in the zone.

### Inputs

| Variables | Eng. Units | Comment |
|---|---|---|
| Zone Pressure | In.w.g. | From Local Controls Based on Outside |
| Setpoint (P_{Outside}) | | Air Conditions and Local Control Settings |
| Zone Pressure | In.w.g. | From Local Controls |
| Reading (P_{Zone}) | | |

### Expected Outcomes of Testing

$${P}_{Outside} ∼ = {P}_{Zone}$$

### Supervisory Control

### Assumptions & Requirements.

Algorithm 5.1 (local) must be in operation and supplying good data.
Algorithms 5.2, 5.3 and 5.4 are not triggered.

```
Algorithm Analysis Procedure Flow
    • If Algorithms 5.2, 5.3 and 5.4 are triggered
          ○ Stop Analysis
    • Acquire time constrained testing bias constants associated with algorithm
instance.
          ○ Property: TestingBiasRelativePressure
          ○ Type: Json
                ▪ UTC_Start
                ▪ UTC_End
                ▪ Values
                    • Name: Test_Bias_Relative_Pressue
                    • Value: 1 inch water (Parameter name:
                Test_Bias_Relative_Pressue)
    • Monitor - Pressure (OutSide and Zone) Procedure
          ○ Calculate ‘Pressures‘
                ▪ For all points ‘Poutsid‘ and ‘Pzone‘ in the zone
                    • Calculate Average Pressure.
                          ○ Aggregation Period: 60 minutes
                          ○ Duration In Alarm: 30 Minutes
                          ○ Apply testing bias
                          ○ Alarm Threshold: > 0.5 inch water (Parameter
                name: Threshold_Relative_Pressure)
    • Notification
          ○ Send notification when alarm trigger zone command dispatched.
                ▪ Notification Restrictions
                    • 1 email notification per day. (Parameter name:
                Notification_Time_Period_Minutes)
```

FIG. 4 shows an exemplary supervisory flow diagram. After Algorithm 5.4, the process evaluates the pressure differential.

### SUMMARY

This algorithm is used to maintain the pressure dynamics in the building and send out notifications if problems are detected.

### Cloud Evaluation Properties

| | |
|---|---|
| Frequency | Evaluate Every 30 min |
| Class | Algorithm_CAMS_Zone_ |
| | RelativePressure_5_1 |

### Expected Outcomes of Testing

The building pressure dynamic in reference to the priority unit is implemented or maintained.

```
    Algorithm 5.2: Adjust Outdoor Air Fraction (OAF) and ACH based on Outdoor and Indoor air
contaminants informed by the acceptable risk threshold research.
    Name: CAMS_Zone_Adjust_OAF_ACH_Contaminants_5_2
    Applicability:
        • All HVAC Zone
    Local Control
    Assumptions & Requirements
        • Outdoor air dampers can modulate
        • Fan speed can modulate
        • PM 2.5 informed by ASHRAE 62.1 or ISO 16890
        • This algorithm is independent of the other algorithms currently. Priorities will be
    created in the next version.
```

FIG. 5 shows Alg. 5.2-L Flow Diagram. This algorithm is used to prioritize IAQ as referenced to PM2.5 by continues analysis of the ratio of indoor to outdoor contamination. If the outdoor contamination is low, the algorithm will increase outdoor air flow overall air exchange rate to remove indoor contamination. If moderate outdoor contamination is detected, the system will decrease the outdoor air fraction while increasing air exchange rate. If the indoor contamination is significantly greater than outdoor contamination, the system will increase air exchange rates without adjusting the outdoor damper, thereby increasing outdoor air flow. If both indoor and outdoor contamination are hazardous, the system will increase ACH significantly then, moderate the outdoor air damper position based on the relative intensity (i.e. increasing outdoor air flow if indoor concentration is higher and vice versa).

### Inputs

| | Eng. | Frequency of | Data |
|---|---|---|---|
| Variables | Units | Sampling | Filtering |
| Particulate | ug/m³ | N/A | NA |
| Matter (PM2.5) (EQ | | | |
| Risk Thresholds) | | | |
| Particulate | ug/m³ | 1 min | 15 Min average |
| Matter (PM2.5) | | | |
| readings from all | | | |
| HVAC Units (Indoor & | | | |
| outdoor) | | | |
| Fan Cmd. | On/Off | 1 min | COV |
| All HVAC | Hz. | 1 min | 15 Min average |
| Units Fan Speed FB | | | |
| All HVAC | 0 to 100% | 1 min | 15 Min average |
| Units OA Damper | | | |
| Position FB | | | |
| Zone Volumes | Ft# | Static | NA |
| Zone | PPM (Proxy) | 1 min | 15 Min |
| Occupancy - CO2 as | | | |
| proxy for Pz | | | |
| Outdoor Air | Yes/No | Hourly | NA |
| Quality Alert | | | |

### Outputs

| Variables | Eng. Units | Frequency |
|---|---|---|
| Fan Speed | Hz. | Every 15 Min |
| CMD | | |
| Fan CMD | On/Off | Every 15 min |
| OA Damper | 0-to 100% | Every 15 Min |
| Position CMD | | |

Expected Outcomes of Testing are detailed in FIG. 6-Alg. 5.2-Priority Table (System Flag Method) while FIG. 7 shows Alg. 5.2 Priority Table (If-then-else Method). In FIG. 6, the indoor contaminant check results in hazardous, cautionary or low outcomes, which affect the fan speed and OAD position.

Linear Interperlation setting for OAF & ACH (Fan Speed)

| | PM 2.5 =< | PM 2.5 > | PM 2.5 =< | PM 2.5 > |
|---|---|---|---|---|
| Edge Point | 15 ug/m3 | 15 ug/m3 | 30 ug/m3 | 30 ug/m3 |
| Fan Cmd. | No | ON | ON | ON |
| | Change | | | |
| ACH (Fan | No | 6.66% increase | 1 | 100% |
| Speed) | Change | available fan speed range | 00% | speed |
| | | for every 1 ug/m3 PM 2.5 | increase | |
| | | increase | | |
| OAF (OA | No | 6.66% increase | 100% | 100% |
| Damper) | Change | available OA damper range | increase | open |
| | | for every 1 ug/m3 PM 2.5 | | |
| | | increase | | |

One embodiment follows the air quality standards as follows:

| | | Primary/ | Averaging | | | |
|---|---|---|---|---|---|---|
| Pollutant | | Secondary | Time | Level | | Form |
| Carbon Monoxide (CO) | | Primary | Eight (8) hours | 9 | ppm | Not to be exceeded more |
| www.epa.gov/co-pollution/table-historical- | | | One (1) hour | 35 | ppm | than once per year |
| carbon-monoxide-co-national-ambient-air- | | | | | | |
| quality-standards-naaqs | | | | | | |
| Lead (Pb) | | Primary and | Rolling three (3) | 0.15 μg | | Not to be exceeded |
| | | secondary | month average | (Note 1) | | |
| Nitrogen Dioxide (NO₂) | | Primary | One (1) hour | 100 | ppb | Ninery-eigth (98th) |
| www.epa.gov/no2-pollution/table-historical- | | | | | | percentile of |
| nitrogen-dioxide-national-ambient-air- | | | | | | one-hour daily |
| quality-standards-naaqs | | | | | | maximum |
| | | | | | | concentration, averaged |
| | | | | | | over three years |
| | | Primary and | One (1) year | 53 ppb | | Annual mean |
| | | secondary | | (Note 2) | | |
| Ozone (O₃) | | Primary and | Eight (8) hours | 0.070 ppm | | Annual fourth-highest |
| | | secondary | | (Note 3) | | daily maximum eight- |
| | | | | | | hour concentration, |
| | | | | | | averaged over three |
| | | | | | | years |
| Particle Pollution (PM) | PM2.5 | Primary | One (1) year | 12.0 μg/m³ | | Animal mean, averaged |
| www.epa.gov/pm-pollution/ | | | | | | over three years |
| table-historical-particulate- | | Secondary | One (1) year | 15.0 μg/m³ | | Annual mean, averaged |
| matter-pm-national-ambient-air- | | | | | | over three years |
| quality-standards-naaqs | | Primary and | Twenty-four | 35 μg/m³ | | Ninety-eight (98th) |
| | | secondary | (24) hours | | | percentile, averaged |
| | | | | | | over three years |
| | PM10 | Primary and | Twenty-four | 150 μg/m³ | | Not to be exceedeed more |
| | | secondary | (24) hours | | | than once per year on |
| | | | | | | average over three years |

### Cloud Evaluation Properties

| | |
|---|---|
| Frequency | Evaluate Every 30 min |
| Class | CAMS_Adjust_OAF_ACH_{—} |
| | Contaminants_5_2 |

```
    Algorithm 5.3: Adjust flow and ACH based on current occupants and current public health
risks
    Name: CAMS_Zone_Adjust_OAF_ACH_Health_Risks_5_3
    Applicability:
        • All HVAC Zones
    Local Control
    Assumptions & Requirements
        • Algorithm 5.3-S must be activated
        • Outdoor air dampers can modulate
        • Fan speed can modulate
        • This algorithm is independent of the other algorithms in one embodiments, while
    in other embodiments a variety of algorithms can be used and priorities will be created in next
    version.
```

FIG. 8 shows the Alg 5.3-L Flow Chart. This algorithm is used to mitigate risk as referenced to community positivity rate by continues analysis of occupancy and public health data. OAF rates and fan speed modulate based on the risk threshold, as determined by the SafeAirSpaces & Alg. 5.3—S. If moderate outdoor contamination is detected, the system will decrease the outdoor air fraction while increasing air exchange rate. If there is a public health risk significantly greater than outdoor contamination, the system will increase the outdoor air by adjusting the damper, thereby increasing outdoor air flow. If both the public health risk and outdoor contamination are hazardous, the system will increase ACH significantly than, moderate the outdoor air damper position based on the relative intensity (i.e. increasing outdoor air flow if the public health risk is higher and vice versa).

| | | Frequency of | |
|---|---|---|---|
| Variables | Eng. Units | Sampling | Data Filtering |
| All HVAC | Hz. | 1 min | 15 Min average |
| Units Fan Speed FB | | | |
| All HVAC | 0 to 100% | 1 min | 15 Min average |
| Units OA Damper | | | |
| Position FB | | | |

### Outputs

| Variables | Eng. Units | Frequency |
|---|---|---|
| Fan Speed | Hz. | Every 15 Min |
| CMD | | |
| OA Damper | 0-to 100% | Every 15 Min |
| Position CMD | | |

### Expected Outcomes of Testing

Please see priority tables in the expected outcomes of algorithm 5.2-L.
Key difference between Algorithm 5.2 and 5.3:
   Alg. 5.2: The triggering variable (risk thresholds) are indoor and outdoor PM2.5
   Alg. 5.3: The indoor risk thresholds are determined by SafeAirSpaces using community positivity rates (COVID).
The responses for both algorithm 5.2-L and 5.3-L leverage the same outputs (Fan speed and OA Damper Position, but with different priority variables

### Supervisory Control

### Assumptions & Requirements.

SafeAirSpaces runs continuesly in CAMS.
CO2 is used as the proxy to calculate Occupancy.
COVID is the first virus used in SafeAirSpaces Algorithm, other viruses will be part of CAMS' next version

FIG. 9 shows Alg 5.3—S Flow Chart with its primary to calculate the risk of viral transmission through aerosols. The process applies public health data and occupancy dynamics (min, max, % per hour, CO2 emission proxy) and captures cell phone pings to the Wifi router. The process compares infection and occupancy trends to determine potential risk. Using zone/HVAC data and public positivity rates, a risk profile is determined by the SafeAirSpaces algorithm. One virus in the SafeAirSpaces algorithm is COVID.

### Inputs

| | | Frequency of | Data |
|---|---|---|---|
| Variables | Eng. Units | Sampling | Filtering |
| Zone Volumes | Ft\hat{ }3 | Static | NA |
| Zone | PPM | 1 min | 15 Min |
| Occupancy - CO2 as | (Proxy) | | |
| proxy | | | |
| Community | % | Daily | NA |
| Positivity Rate | | | |
| (COVID) | | | |

### Outputs

| Variables | Eng. Units | Frequency |
|---|---|---|
| Risk Profile | NA | Daily |

### Cloud Evaluation Properties

| Frequency | Evaluate Every 30 min |
|---|---|
| Class | CAMS_Zone_Adjust_OAF_ACH_Health_Ri |
| | sks_5_3 |

### Expected Outcomes of Testing

One version has three levels of risk:
Low
Cautionary
Hazardous

```
    Algorithm 5.4: Isolate and evacuate indoor air contaminants based on indoor IAQ sensors
    This algorithm monitors the health parameters of a HVAC zone and will initiate mitigation
notifications and actions.
    Name: CAMS_Zone_Isolate_Indoor_Air_Contaminants_5_4
    Applicability
        • HVAC Zones where occupancy type is not kitchen
    Local Control
    Local HVAC control will initiate actions to evacuate air health hazards to the outside when
triggered by cloud supervisor monitors.
    Assumptions & Requirements
        • Supported only for HVAC Zones
    Commands / Events
        • Commands from Supervisor
              ○ Command - Evacuate
                    ▪ Name: HVAC_Zone_Evacuate_Air
                    ▪ State: True = Initiate / False = Terminate
                    ▪ Duration: 35 minutes unless canceled
                    ▪ Periodicity: 30 minutes
                    ▪ Local control actions:
                        • Fan Control
                              ○ GFan = 0
                              ○ VFD Speed = 0
                        • Adjust damper settings:
                              ○ Exhaust: full open
                              ○ Outside Air / Economizer: full open
                              ○ Return Air: full closed
              ○ Command - Hyper Ventilate
                    ▪ Name: HVAC_Zone_Hyper_Ventilate
                    ▪ State: True = Initiate / False = Terminate
                    ▪ Duration: 35 minutes unless cancelled
                    ▪ Periodicity: 30 minutes
                    ▪ Local control actions:
                        • Fan Control
                              ○ GFan = 1
                              ○ VFD Speed = 100%
                        • Adjust damper settings:
                              ○ Exhaust: Normal Operations
                              ○ Outside Air / Economizer: 100%
                              ○ Return Air: Normal Operations
    Supervisory Control
    Supervisory controls will monitor zone health, initiate local control commands and send
notifications via email.
    Assumptions & Requirements
        • Configured for all zones to be monitored and controlled.
        • Cannot be used with Kitchen zones
        • Sites/Floor must contain more than one zone.
```

```
Algorithm Analysis Procedure Flow
      • Acquire time constrained testing bias constants associated with algorithm
instance.
            ○ Property: Test Bias Particulate Matter 2.5
                  ▪ UTC_Start
                  ▪ UTC_End
                  ▪ Values
                      • Name: Test_Bias_PM_2_5
                      • Value: 40 ug/m3 (Parameter name: Test_Bias_PM_2_5)
      • Monitor - Particulate Matter 2.5 Procedure
            ○ For all zones of a floor or building.
                  ▪ Calculate ‘PM2_5‘ applying testing bias if current time in testing
          bias range.
                      • For all points ‘PM2_5‘ in the zone
                            ○ Calculate particulate level and determine if in
                    alarm.
                                ▪ Aggregation Period: 60 minutes
                                ▪ Duration In Alarm: 30 Minutes
                                ▪ Alarm Threshold: > 40 ug/m3
                            (Parameter name: Threshold_PM_2_5)
            ○ Determine zone with highest particulate level and in alarm state.
                  ▪ Set this zone as ‘Priority‘ zone.
                      • Note: During nominal operations there will not be a
                ‘Priority‘ zone.
                  ▪ If ‘Priority‘ zone identified.
                      • Record all others as ‘Non-Priority‘ zone
      • Command Initiation
            ○ If Local Control Commands enabled.
                  ▪ If ‘Priority‘ zone identified send commands
                      • ‘Priority‘ zone command
                          v○ Lockout all other CAMS Algorithms
                            ○ Send ‘HVAC_Zone_Evacuate_Air‘ command
                      • ‘Non-Priority‘ zone command
                            ○ Send ‘HVAC_Zone_Hyper_Ventilate‘
                    command
      • Notification
            ○ Send notification when ‘Priority‘ zone command dispatched.
                  ▪ Notification Restrictions
                      • 1 email notification per day. (Parameter name:
                  Notification_Time_Period_Minutes)
```

FIG. 10 shows an exemplary Alg. 5.4—S Flow Diagram.

### Cloud Evaluation Properties

| | |
|---|---|
| Frequency | Evaluate Every 30 min |
| Class | CAMS_Zone_Isolate_Indoor_Air_{—} |
| | Contaminants_5_4 |

### Expected Outcomes of Testing

The priority unit's pressure zone pressure will drop and surrounding zones pressure will increase. This will result in an inflow of air to the ‘Priority’ from surrounding zones and the evacuation of the air via the rooftop. Also, an email will be sent to the facility manager at a maximum frequency of once per day.

```
Algorithm 5.5: Respond to a public health crisis or a catastrophic event.
Name: CAMS_Zone_Public_Health_Crisis_Catastrophy_5_5
Applicability
      • HVAC Zones where occupancy type is not kitchen
Local Control
Assumptions & Requirements
      • All zones that have economizer and are not kitchens
      • Initiated when commanded by the supervisory control system to do a local zone
flush
      • Economizers will open to 100% during local zone flush
      • Local Zone flush command will be reevaluated every 30 minutes by supervisor
      • Local Zone flush will automatically cease when outdoor AQI is worse than
indoor AQI as determined by supervisor.
      • Economizers go to 0% when outdoor AQI is worse than indoor AQI as
determined by supervisor.
      • When CO2 exceeds 3,000 PPM, cancel and let local algorithms run as normal
      • Local controls will automatically cancel any supervisor command after 35
minutes of runtime.
Commands / Events
      • Commands from Supervisor
            ○ Command - Flush
                  ▪ Name: HVAC_Zone_Flush
                  ▪ State: True = Initiate / False = Terminate
                  ▪ Duration: 35 minutes unless canceled or CO2 is greater than
            3,000 PPM
                  ▪ Periodicity: 30 minutes
                  ▪ Local control actions:
                      • Economizer = Full Open
                      • Fan = On
                      • VFD Speed = 100%
                      • Air Purifiers = On
            ○ Command - Recirculate
                  ▪ Name: HVAC_Zone_Recirculate
                  ▪ State: True = Initiate / False = Terminate
                  ▪ Duration: 35 minutes unless cancelled or C)2 is greater than
            3,000 PPM
                  ▪ Periodicity: 30 minutes
                  ▪ Local control actions:
                      • Economizer = Full closed
                      • Fan = On
                      • VFD Speed = 100%
                      • Air Purifiers = On at Zone Maximum Level
```

### SUMMARY

1. Level 5 AQI Forecast-Triggered algorithm
2. Issue Email Alert with Site Mitigation strategies Explanation-2 hours prior to Forecast
3. With in one hour of forecast Level 5 AQI Event issue flush command to local controls
4. With in 30 min of forecast Level 5 AQI Event turn on air purifiers
5. At Level 5 AQI-forecasted time, close economizers to 0%
6. When CO2 exceeds 3,000 PPM, or outdoor AQI drops below 5, cancel and let local algorithms run as normal

### Supervisory Control

### Assumptions & Requirements

See local controls section.

```
Algorithm Analysis Procedure Flow
      • Acquire time constrained testing bias constants associated with algorithm
instance.
            ○ Property: Test Bias AQI Forecast Current Hour
                  ▪ UTC_Start
                  ▪ UTC_End
                  ▪ Values
                      • Name: Test_Bias_AQI_Forecast_Current_Hour
                      • Value: 0-5
                      • Description: AQI Bias.
            ○ Property: Test Bias AQI Forecast Minutes To Hazardous
                  ▪ UTC_Start
                  ▪ UTC_End
                  ▪ Values
                      • Name: Test_Bias_Minutes_To_Hazardous
                      • Value: 0-5
                      • Description: AQI Bias.
            ○ Property: Test Bias AQI Actual Outdoor
                  ▪ UTC_Start
                  ▪ UTC_End
                  ▪ Values
                      • Name: Test_Bias_AQI_Actual_Outdoor
                      • Value: 0-5
            ○ Property: Test Bias AQI Actual Indoor
                  ▪ UTC_Start
                  ▪ UTC_End
                  ▪ Values
                      • Name: Test_Bias_AQI_Actual_Indoor
                      • Value: 0-5
            ○ Property: Zone Time to Flush
                  ▪ UTC_Start: N/A
                  ▪ UTC_End: N/A
                  ▪ Values
                      • Name: Zone_Time_To_Flush_Minutes
                      • Value: 0 - 180 Minutes
            ○ Property: Hazardous AQI Threshold
                  ▪ UTC_Start: N/A
                  ▪ UTC_End: N/A
                  ▪ Values
                      • Name: Hazardous_AQI_Threshold
                      • Value: 5
      • Monitor
            ○ Air Quality Indexes (Indoor and Outdoor)
                  ▪ Determine AQI Index for current and next 3 hours
                      • Indoor - Current Hour/Time
                      • Outdoor - Current Hour/Time
                      • Forecast - Current and next three hours
                  ▪ Apply testing biases to all AQI values.
      • Command Initiation
            ○ Flush (HVAC_Zone_Flush)
                  ▪ Initiate when
                      • Outdoor AQI actual current < 5
                        and
                      • Outdoor AQI Forecast Current_Hour < 5
                        and
                      • Outdoor AQI Forecast Range[Current_Hour to
                  CurrentHour + Zone_Time_To_Flush_Minutes] any value >= 5
            ○ Recirculate (HVAC_Zone_Recirculate)
                  ▪ Initiate when
                      • Outdoor AQI actual current >= 5
                        or
                      • Outdoor AQI forecast next hour >= 5
      • Notifications
            ○ Flush (HVAC_Zone_Flush) Initiated
                  ▪ Send notification.
                      • Notification Restrictions
                            ○ 1 email notification per day. (Parameter name:
                      Notification_Time_Period_Minutes_Flush_Initiated)
            ○ Recirculate (HVAC_Zone_Recirculate) Initiated
                  ▪ Send notification
                      • Notification Restrictions
                            ○ 1 email notification per day. (Parameter name:
                      Notification_Time_Period_Minutes_Recirculate_Initiated)
```

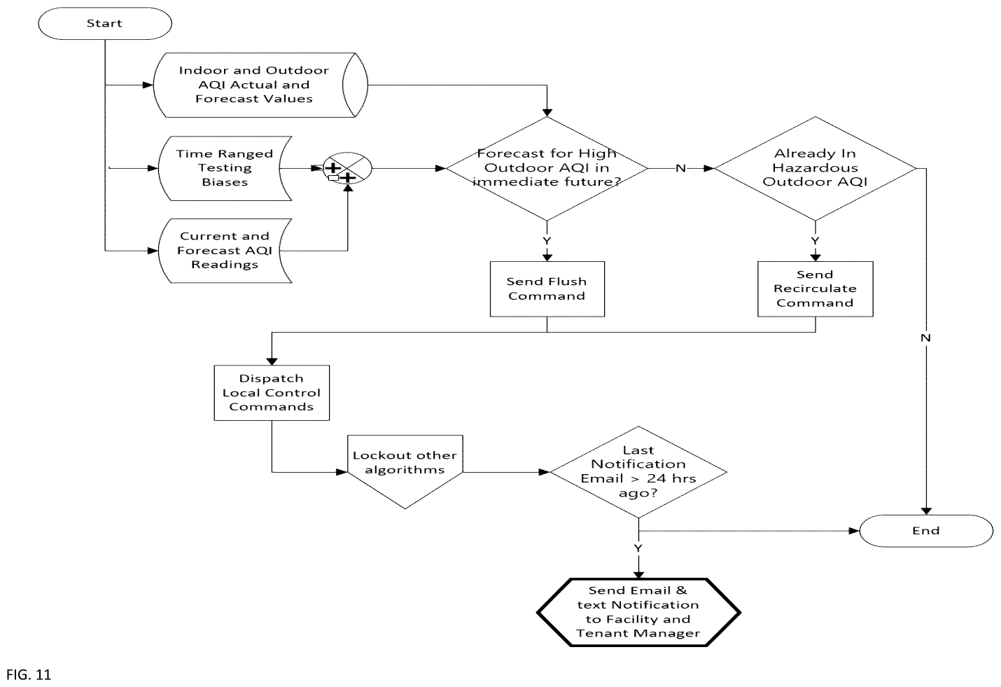

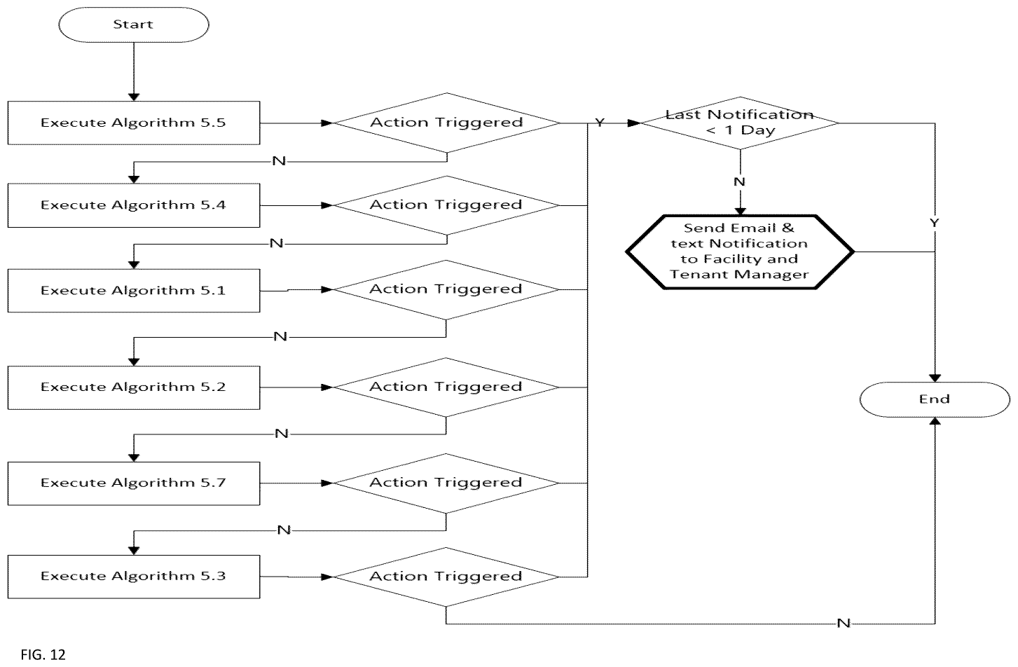

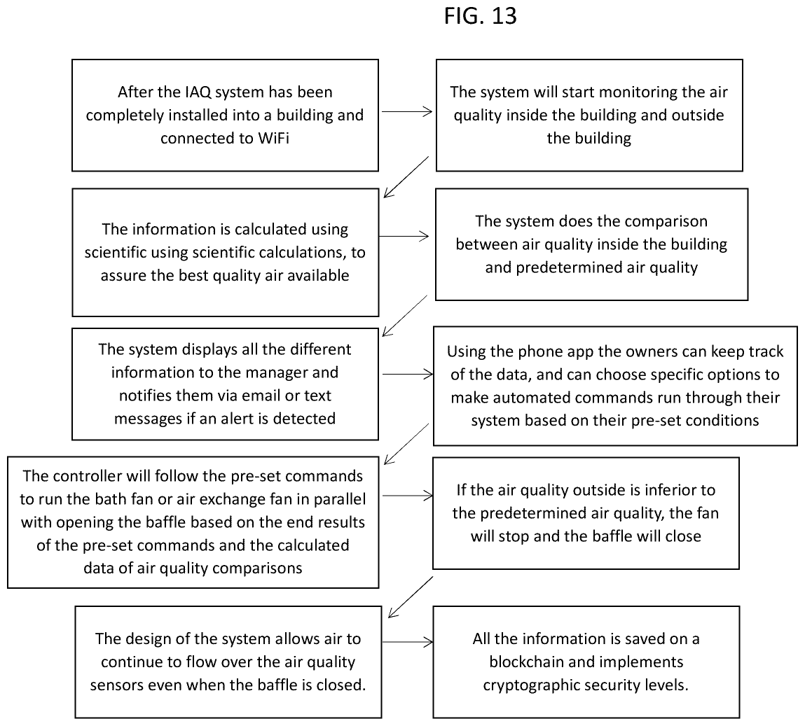

FIG. 11 shows an exemplary Alg. 5.5—S Flow Diagram while FIG. 12 shows Alg. 5.6—S Flow Diagram

### Cloud Evaluation Properties

| | |
|---|---|
| Frequency | Evaluate Every 30 min |
| Class | CAMS_Zone_Public_Health_Crisis_{—} |
| | Catastrophy_5_5 |

### Expected Outcomes of Testing

Zone air will be flushed prior to crisis and recirculated during the event. Additionally, air purifiers will be engaged during the event.

```
Algorithm 5.6: Zone Algorithm Executive
Name: CAMS_Zone_Executive_5_6
Applicability
      • ALL HVAC Zones
Local Control
No direct local control functions are associated with this algorithm.
Supervisory Control
This algorithm orchestrates the sequencing and invocation rules for all CAMS zone algorithms.
Assumptions & Requirements
      - Algorithms Orchestrated
            ○ Algorithm 5.1
            ○ Algorithm 5.2
            ○ Algorithm 5.3
            ○ Algorithm 5.4
            ○ Algorithm 5.5
            ○ Algorithm 5.7
      - Execution Order (Sequential) See following diagram
            ○ Algorithm 5.5
            ○ Algorithm 5.4
            ○ Algorithm 5.1
            ○ Algorithm 5.2
            ○ Algorithm 5.7
            ○ Algorithm 5.3
      - Trigger Rule(s)
            ○ If an algorithm is triggered. algorithms following the triggered algorithm
      shall be ignored.
                  ▪ Foreach Algorithms not yet executed in the execution sequence.
                      • Only execute each of their return to normal command
                  sections.
```

### Cloud Evaluation Properties

| | |
|---|---|
| Frequency | Evaluate Every 30 min |
| Class | CAMS_Zone_Executive_5_6 |

```
    Algorithm 5.7 SafeAirSpaces
    Name: CAMS_Zone_Safe_Air_Spaces_5_7
    Applicability
          • Used in conjunction with 5.3
    Local Control
    This algorithm runs subordinate to other supervisory
algorithms. Hence, there is not a local control specification.
Supervisory Control
TBD
```

### Cloud Evaluation Properties

| | |
|---|---|
| Frequency | Evaluate Every 30 min |
| Class | CAMS_Zone_Safe_Air_Spaces_5_7 |

```
Algorithm 5.8 Health Alerts
Name: See PointMonitors
Applicability
      • Any point that collects time series data.
Supervisory Control
      • For any point, configure a threshold and Time in-alert monitor. Points monitored
will depend on regional air quality and public health threats.
            ○ Threshold Value
                  ▪ Flosting point numeric value
            ○ Threshold Types
                  ▪ Above Threshold
                  ▪ Below Threshold
                  ▪ Equal To
                  ▪ Not Equal To
            ○ Duration
                  ▪ Minimum Time in threshold constraint violation
      • The alert will provide extra mitigation strategies to mitigate the threat.
            ○ Links
            ○ Phone numbers
            ○ Step by step info, etc
      • CAMS generalized point monitors provide this functionality.
```

### Cloud Evaluation Properties

| | |
|---|---|
| Frequency | Evaluate as point values are received. |
| Application | See Func-PointMonitor application. |

One implementation applies neural networks to predict air quality. The modeling and forecasting of building environmental parameters involves a variety of approaches. By considering the fan air flow speed, the pathogen, the number of people, and the operation time for different fans, the data can be taken in 15 min interval time for several days. The data taken are then divided into two major parts: simulation (training and validation) and testing according to the rule set by Environmental Protective Agency (EPA). The tool can predict and control air pathogen or pollution. One approach applies an atmospheric air flow diffusion model to predict future pathogen or pollutant concentrations. A second is to devise statistical models that attempt to determine the underlying relationship between a set of input variables (original data) and the targets. Statistical methods, either the time-series methods, which do not use air flow inputs, or regression and similar methods, which are based on multivariate linear relationship between air flow conditions and air pathogen/pollution concentrations, can be used. A parallel genetic algorithm (GA) can be employed for selecting the inputs and designing the high-level architecture of a multi-layer perceptron model for forecasting hourly concentrations of pathogen in the building The evolutionary and genetic algorithms (GA) can solve linear and non-linear problems by exploring all regions of the state space and exploiting promising areas through genetic operations. GA can find the optimal operating conditions so that the overlimit release of pathogen is reduced to the allowable limit.

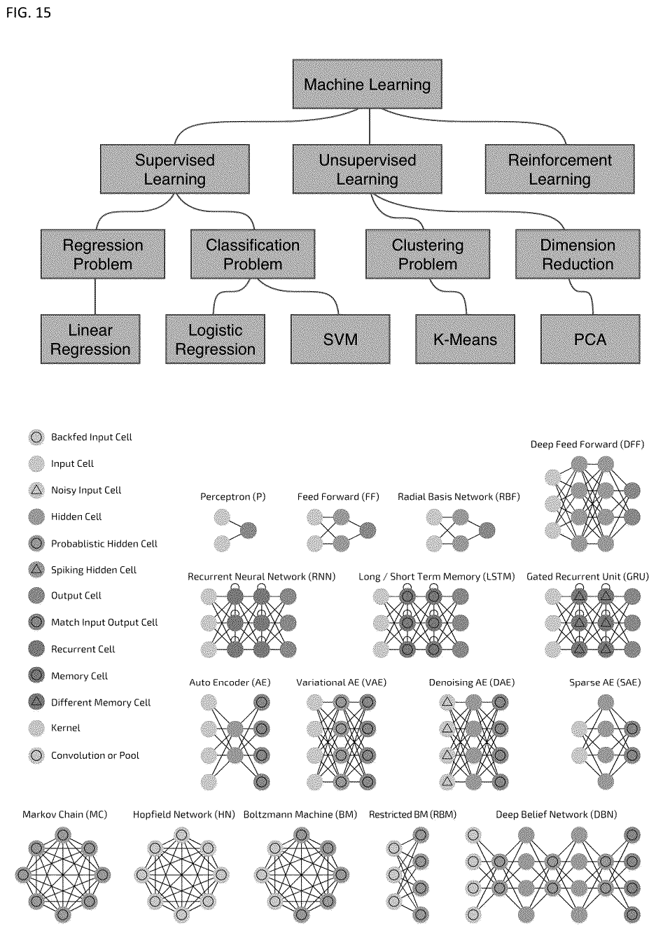

In another embodiment, artificial neural networks (ANN) can be used. FIG. 15 shows exemplary AI networks to perform air management. In addition to controlling the air quality operation, the neural network can be used to provide local edge processing for IoT devices. A striking feature about neural networks is their enormous size. To reduce size of the neural networks for edge learning while maintaining accuracy, the local neural network performs late down-sampling and filter count reduction, to get high performance at a low parameter count. Layers can be removed or added to optimize the parameter efficiency of the network. In certain embodiments, the system can prune neurons to save some space, and a 50% reduction in network size has been done while retaining 97% of the accuracy. Further, edge devices on the other hand can be designed to work on 8 bit values, or less. Reducing precision can significantly reduce the model size. For instance, reducing a 32 bit model to 8 bit model reduces model size. Since DRAM memory access is energy intensive and slow, one embodiment keeps a small set of register files (about 1 KB) to store local data that can be shared with 4 MACs as the leaning elements). Moreover, for video processing, frame image compression and sparsity in the graph and linear solver can be used to reduce the size of the local memory to avoid going to off chip DRAMs. For example, the linear solver can use a non-zero Hessian memory array with a Cholesky module as a linear solver.

In another embodiment, original full neural network can be trained in the cloud, and distillation is used for teaching smaller networks using a larger “teacher” network. Combined with transfer learning, this method can reduce model size without losing much accuracy. In one embodiment, the learning machine is supported by a graphical processing unit or GPU on a microprocessor, or to reconfigure the Field Programmable Array or FPGA used as part of the baseband processing as neural network hardware. The above Cloud Software Suite of Applications (SuperApp) Providing Intelligent Tools for Buildings Services. It Integrates Smart Building Systems (Building Service Providers) Providing Monitoring, Analytic and Supervisory services.

An ensemble of neural networks is a machine learning concept where multiple neural networks, or models, are trained and their predictions are combined in some way to make a final prediction. This approach is often used to improve the performance of a model by leveraging the strengths of each individual model in the ensemble. The idea is that while each model may have its own weaknesses, by combining them, the ensemble as a whole can make more accurate predictions. In the context of air quality management, an ensemble of neural networks can be used to gather and analyze data from a variety of sources, such as government agencies, adjacent buildings, and sensors within the building itself. Each neural network in the ensemble could be trained on a different subset of the data or use a different architecture, allowing it to specialize in recognizing certain patterns or trends. The predictions from each network can then be combined to provide a more comprehensive understanding of the air quality. For example, one network might be trained on data from government air quality sensors, another on data from sensors in nearby buildings, and another on data from sensors within the building being managed. Each network would learn to make predictions based on its specific data source, and these predictions could then be combined to provide a more comprehensive prediction of the overall air quality. The ensemble approach can provide high quality air quality forecasting. For instance, the ensemble approach for multi-source transfer learning can predict air quality in cases of sparse data. The ensemble of neural networks can be a powerful tool for air quality management, allowing for the integration of data from multiple sources and the leveraging of the strengths of multiple models to provide accurate and comprehensive air quality predictions.

The preferred embodiment relates to a system for managing air quality within a specified space. Specifically, the system is capable of functioning within a variety of spaces such as a commercial building, a single floor of a building, an individual house or even a specific room within a building. The intended application of this system is not limited by the size or type of space in which it is employed. The incorporation of this system in the constructed environment provides real-time control over air quality, impacting comfort, health, and overall wellbeing of the occupants. Furthermore, the system is designed with an emphasis on predictive control mechanisms, thereby providing users with advance information and control options related to air quality.

The core feature of the disclosed system is its adaptability, using third-party, future forecast air quality conditions. By using data provided by external forecast sources, the system actively anticipates changes in air quality. This ability to predictively control air quality conditions provides an advanced response rather than a reactionary one, offering improved preparedness for changes in air quality. The system, thereby, allows for adjustments in real-time to meet the anticipated air quality conditions, ensuring optimal environmental conditions for the occupants. This sophisticated approach to air quality management offers increased effectiveness while mitigating potential health risks from poor air quality, by proactively engaging necessary changes before the air quality deteriorates.

The preferred embodiment also offers a unique approach to integrating technology and environmental management. The robustness of this system allows for implementation in a range of spaces, from large commercial buildings to a single room in a house. The system's adaptability makes it useful in various types of structures, regardless of their design or purpose, providing a customized solution for each application. By harnessing future third-party forecasted air quality conditions, the system enables a more precise, dynamic way of maintaining optimal air quality. It becomes an integral part of the day-to-day operations of the space it is implemented in, optimizing indoor air quality for enhanced comfort, productivity, and health. As environmental conditions continue to change, this system offers a reliable and adaptive approach to proactive air quality control.

The preferred embodiment encompasses a highly advanced approach for the quantification of health impacts of building occupants caused due to exposure to indoor contaminants. The central component of this system is the unique code formulated to evaluate the relationship between indoor contaminants and occupant health. This advanced software program capitalizes on complex algorithms and tools to determine the overall impact accurately. Indoor contaminants are universally prevalent and are distinguished by a substantial diversity that includes particulate matter, biological debris, volatile organic compounds (VOCs), etc. These contaminants can instigate a multitude of health complications that includes allergies, respiratory issues, or even chronic diseases. This preferred embodiment signifies a significant leap forward in our understanding and management of indoor environmental quality and serves as an invaluable tool for building managers, building occupants, health professionals, and researchers.

The system design can accommodate an extensive population of buildings with diverse structural characteristics, infrastructure, and occupant demographics, ensuring its wide applicability. The code performs comprehensive and granular data analytics to understand the correlation between various elements that contribute to indoor pollution and individual health. It conducts real-time quantification which can be updated based on the dynamic variations in the indoor environment and health statistics of the building's occupants. Notably, the system also infers the potential degree of harmful health effects on individuals per exposure duration and contaminant type present. Moreover, the proprietary code of the system can predict the likelihood of health risks from future exposures, allowing preemptive measures, preventive healthcare, and maintenance of optimum indoor quality.

The unique and revolutionary elements of the preferred embodiment contribute significantly to the advancement of health and safety measures in indoor environments. The maestros of statistical analysis, the incorporated algorithms break down the complex interaction between indoor contaminants and the wellbeing of occupants, facilitating informed decision making. Through its innovative risk identification processes and the ability to provide specific, actionable data, this system serves as a preventative health tool. Thereby, it supports healthier buildings and promotes a safer, more comfortable living environment for occupants. Given its benefits and forward-thinking approach, it is foreseen that the introduced system, empowered by its novel coding mechanism, would be a stalwart in both established and emerging building health assessment arenas.

The preferred embodiment pertains to a system that incorporates a mechanism to generate indoor air contaminant risk-mitigation control strategies. These strategies are based on data sourced from a community located in geometric proximity or a neighborhood. This dynamic system is designed to accumulate and process large quantities of data related to air quality and contamination levels. It absorbs information about different types of contaminants present in the air, their concentrations, sources, and potential risks associated with them. The system then furnishes control strategies interlinking all these aspects holistically. The fundamental objective is to ensure a clean, healthy, and safe indoor environment. Its applicability can be found in various domains, for instance, industrial environments, office buildings, households, and public facilities, among others.

The uniqueness of this system stems from its ability to utilize local data from a community or neighborhood, rather than relying on generalized data. This customized approach allows the system to consider factors such as the distinct environmental conditions, unique pollutant sources, concentration levels, and local weather patterns that might influence indoor air quality in that particular geographical area. The system is developed with advanced algorithms that enable it to process this data and generate tailored, effective control strategies accordingly. The system can advise on implementing solutions like air purifiers, ventilation adjustments, or dehumidifiers, depending upon the conditions. It is proactive rather than reactive, predicting potential risks and advising on mitigation measures beforehand.

Moreover, the system comprises a user interface that makes it convenient for the users to access the analyzed information and the suggested mitigation strategies. It also comes with a feedback mechanism where users can report the efficiency of the suggested strategies, therefore allowing the system to improve and adapt over time. It provides an essential tool to fight against indoor air pollution, which has become a growing public health concern worldwide. By making use of technology, the system offers a solution to improve the indoor air quality, mitigate the risks associated with indoor air contaminants, and consequently improve the overall health and well-being of the community.

The preferred embodiment relates generally to a system for optimizing the placement of air quality sensors in a ventilation system. The innovative aspect of the system lies in its unique ability to model airflow patterns. This modeling serves as a guide to determine the most strategic positions for air quality sensors in ventilation systems. This method of placement increases the efficiency and overall effectiveness of the ventilation system by ensuring all air locations get monitored adequately. To achieve this, the system employs a code specifically designed to simulate airflow patterns in the selected environment. It aids in identifying areas with potentially varied airflow dynamics that might require more comprehensive sensor coverage.

The system also includes an algorithm for using the modeled airflow patterns to place the air quality sensors. By modeling the airflow patterns, the algorithm procures a thorough understanding of the environment before placing the sensors. Divine conjectures such as dead-zones i.e., areas receiving little to no fresh air or high-risk areas including those with excessive moisture or contaminants can be made. This innovative approach improves the effectiveness by covering all areas for air quality monitoring and results in a more data-driven, intelligent placement of sensors.

Furthermore, the system is designed to incorporate sensor-placement adjustments over time based on changes in the modeled airflow patterns. For instance, the system can adapt to evolving building designs, physical alterations in ventilation systems, and dynamic air conditions. It can re-evaluate and re-position the sensors whenever necessary to ensure effective coverage continually. Notably, this system has broad application and could be implemented in a myriad of environments such as buildings, underground stations, industrial sites, etc., where adequate ventilation and air quality monitoring are integral for health, safety, and efficiency purposes. This unique approach of using code for modeling airflow patterns determines the exact placement of air quality sensors, facilitating precise and effective air quality monitoring.

The system provides a system for modeling airflow patterns that links this dynamic data with the strategic placement of air quality sensors within a ventilation system to ensure optimally efficient and effective air quality monitoring.

The preferred embodiment relates generally to the management of energy consumption in a space. It specifically encompasses the development of an innovative system that utilizes specific code to effectively assess energy consumption using energy disaggregation of appliances associated within the space. The preferred embodiment provides an intelligent, sophisticated method for analyzing and evaluating the amount of energy consumed by individual appliances, enhancing an individual or organization's capacity to monitor, control, and potentially reduce their overall energy consumption.

The preferred embodiment introduces a distinguishing feature in the form of particular code that effectively performs the task of energy disaggregation. The algorithmic construct embedded within this code disaggregates the overall energy consumed into specific compartments corresponding to each appliance. The code, thus, intelligently detects, segregates, and measures the amount of energy consumed by each appliance in real-time. This novel code, therefore, not only identifies the appliances in use and the energy consumption related to it but also aids in identifying patterns of usage and potential areas of energy inefficiencies. With such accurate and real-time data, users can make an informed decision about the use of their appliances to optimize energy consumption.

In the broader picture, this preferred embodiment serves as a crucial tool in the global efforts to reduce energy consumption and curtail environmental degradation. It provides a mechanism to foster awareness about the energy usage footprint of appliances in homes, offices, or any space utilizing any form of energy-consuming appliances. The energy disaggregation capabilities of this system allow for increased precision on energy end-use information, thereby elucidating patterns and providing opportunities for targeted energy-saving measures. By facilitating better consumption habits and promoting energy-efficient usage of technology, the preferred embodiment contributes significantly to sustainable living and the future of energy management.

The preferred embodiment relates to a system for maintaining a predetermined pressure in predefined spaces for various applications like air-conditioning systems, clean rooms, laboratories, industrial applications, etc. It involves an implementation of algorithmic code that monitors, controls, and maintains a predefined level of pressure within each space configured in the system. The maintenance of air pressure can be critical in various environments, especially those which require a defined level of atmospheric pressure for optimal operation functionality, or for safeguarding against potential external contamination threats. The inventive system provides an efficient, automatic methodology that not only significantly conserves energy by operating only when required but also ensures the creation of a safe, controlled environment that aligns with required standards.

The system of the preferred embodiment has been creatively designed to incorporate a variety of sensors, processors, and controllers. The sensors capture real-time pressure data from each specified environment, which are then processed by the system's core unit. If the pressure within any space deviates from its predetermined value, the pertinent controller actuates necessary mechanisms to either increase or decrease the pressure until it reverts back to its designated parameter. The core of this system is the code that is capable of managing multiple spaces simultaneously, with minimal error margin and maximum operational efficiency. As a consequence of this real-time, automated functioning, the system can swiftly detect and rectify any deviations, hence preventing any potential disruption or damage that could be caused due to pressure fluctuations.

Consideration of environmental impact and energy conservation have also played key roles in the development of this preferred embodiment. The system only activates mechanisms to alter pressure when required, reducing unnecessary energy expenditure. Furthermore, the system's ability to maintain a consistent, predetermined pressure within each environment enhances the operational efficiency and effectiveness of machineries or experiments conducted within these spaces. Over time, this not only results in energy savings but also significantly reduces the costs associated with potential damage repair or experiment failure due to unstable pressure conditions. Hence, the described system presents an all-encompassing solution to the challenges associated with pressure management within various environments, ensuring both economic and operational benefits.

The preferred embodiment primarily relates to an automated system for moderating indoor air quality by modulating the Outdoor Air Fraction (OAF) and Air Changes per Hour (ACH). Traditionally, methods of controlling indoor air quality have been fairly static because they cannot adjust based on pollutants present. This preferred embodiment, however, introduces an adaptive approach that takes into consideration the concentration of both outdoor and indoor air contaminants. The system is informed by an acceptable risk threshold of pollutants and pathogens, set in alignment with established air quality standards. In the event that the outdoor air quality drops below the said threshold, the system will respond by lowering or ceasing the intake of outdoor air.

More significantly, the system also regulates air flow and ACH based on the occupants' risk of infection, aligning it with public health standards. As such, when the rate of potential infection risk is high, the system will increase the ACH to minimize the amount of pathogen in the air. This makes for a safer indoor environment, increasing the potential for disease prevention and improving the overall well-being of the building occupants. The system's flexibility to adapt to varying circumstances and risk levels is its key distinguishing factor.

This preferred embodiment encompasses a sophisticated algorithmic code that drives its unique capability. This code works by managing several variables such as the quantity and quality of air intake, the capacity of indoor spaces, the nature of the contaminants, and the number of occupants in the area. All these variables work together synergistically to mitigate the risk of disease transmission and improve indoor air quality. Thus, this patent offers a proactive solution to address air quality control in settings where healthy environments are paramount, such as hospitals, offices, and schools, thereby enhancing overall public health safety.

The preferred embodiment relates to a system that performs edge processing of an Automated Clearing House (ACH) to deliver real-time control using a distributed processing architecture. This architecture is designed in such a way that each building within the system undertakes its own data fusion process, improving the efficiency and response time of the system considerably. The data used in this fusion process is derived from various sources that include health or safety data from government servers, climate data from weather servers, and local building data from nearby properties. The aggregation and analysis of these disparate data types can yield valuable insights and enable proactive, data-driven decisions related to the building's management and operation.

The implementation of edge processing in this context is a significant aspect of the preferred embodiment as it allows for local data processing at the edge of the network. Localizing the data processing capacity reduces the latency associated with sending data to a central hub for processing and then waiting for results to be sent back. Edge processing is particularly beneficial in scenarios that require real-time control or prompt decision-making. The system leverages the computational capabilities available at each site to assimilate and analyze datasets from varied sources to influence and control local building operations based on situational parameters such as health alerts, weather conditions, and data from nearby buildings pertinent to building operation.

The safety data from government servers would include any public health advisories or safety guidance, which would be particularly useful during outbreaks of contagious diseases. Climate data, on the other hand, could help optimize energy usage in buildings according to the prevailing weather conditions. Similarly, building data from other premises within the vicinity can contribute to creating a holistic understanding of the local dynamics that can influence decision-making related to operations and security. The system, therefore, allows each building in the network to act both independently and in synergy with the others, facilitating a comprehensive autonomous operation that accounts for a multitude of influencing factors.

The preferred embodiment relates to a system that employs an ensemble of machine learning (ML) models, fast forest methods, change-point determination, stochastic models, and coefficients integrated with CoolingDegree Days (CDD) and HeatingDegree Days (HDD). This ensemble creates a versatile and effective framework for analyzing and predicting diverse data streams. ML models capture intricate patterns and relationships within the high-dimensional input data and their labels, providing powerfully predictive and interpretive capabilities. The fast forest methodology, a tree ensemble learning approach, offers further benefits in terms of lower computational complexity and improved robustness to outliers and noise. These components collectively contribute to the system's predictive efficiency while striking an optimal balance between bias and variance.

The system also capitalizes on change-point detection in data sets, a technique used to infer the points where the statistical properties before and after the change point diverge. This allows the system to detect abrupt regime changes, trends, and cyclic patterns in the data, offering additional insights and allowing for more fine-tuned predictions. The integration of stochastic models in the ensemble further enhances its performance. These models help in understanding random fluctuations that are often implicit in observed data and contribute to generating robust predictions, even in the presence of noisy and imperfect data. With these multidimensional capabilities, the system can effectively model, predict, and analyze complex system behaviors, patterns, and trends.

Lastly, the system incorporates the concept of cooling degree days (CDD) and heating degree days (HDD) as coefficients. These are measures of how much and how often the outside air temperature is above or below a certain threshold. These metrics are crucial in the energy industry, particularly for predicting energy usage and managing its impacts on the environment. By integrating CDD and HDD into the ensemble, the system can model energy usage in response to a temperature change accurately. This feature can prove invaluable to various industries, such as the energy and environmental industries, where precise forecasting permits efficient usage of resources and potential mitigation of adverse environmental effects.

The air management system is capable of detecting, isolating, and evacuating indoor air contaminants in real-time. This system incorporates a sophisticated code which integrates with advanced indoor air quality sensors for the detection of pollutants. The sensors employed can monitor chemical compounds such as volatile organic compounds, carbon monoxide, carbon dioxide, as well as physical particles like dust, moulds, or allergens. The sensor data is collected and analysed continuously, allowing for an accurate representation of the indoor air quality at any given time.

The preferred embodiment deviates from existing air management solutions by the inclusion of the unique real-time smart isolation feature. Once the system detects a pollutant or particle that surpasses a predetermined threshold, the code is designed to direct actuation mechanisms, such as automated doors, windows, or air vents, to seal off the affected area. The swift and automatic isolation can prevent the spread of harmful contaminants, ensuring that the impacted area is confined and that the indoor air quality of other regions within the premises remains unaffected. By incorporating this smart isolation feature, the preferred embodiment provides a proactive and strategic approach to managing and improving indoor air quality.

The system effectively removes the detected pollutants from the isolated area. This is achieved via integration with existing air purification or ventilation systems. Through the strategic activation of these systems, the preferred embodiment ensures efficient expulsion or filtration of the detected contaminants. Moreover, the evacuation phase can be fine-tuned based on the type and concentration of the pollutant detected, ensuring optimal usage of energy while maintaining top-quality indoor air conditions. The preferred embodiment, therefore, provides a comprehensive, smart, and energy-efficient solution to managing indoor air quality, promising enhanced health and comfort within interior environments.

The present system includes code for monitoring zone health, initiating local control commands as well as sending notifications via email. Primarily, this system can monitor the health of different zones such as a specific area, region, or district in an organization, technology system or network. This is done through the integration of sensors, data analytics algorithms and real-time data monitoring tools embedded within the system. This code in question gathers essential data related to performance, operation and any anomalies that occur within these zones. In the event of any discrepancies or significant changes in patterns, this inventive system is equipped to respond swiftly with local control commands, which essentially refers to operational adjustments within the local system to manage potential risks.

Furthermore, in addition to dynamically overcoming challenges by initiating swift local control commands, the notified system boasts the capabilities to send notifications via email, thereby ensuring prompt alertness and quick response. It consolidates all crucial information, analyzes the overall situation and then prepares a comprehensive report. This report is then dispatched as an email notification to the relevant party or stakeholders who potentially can remediate the situation. This facet of the system ensures that the correct people are notified in real-time, empowering them with the information they need to make informed decisions.

The system is extremely versatile and can be integrated into a wide array of platforms. From network stations to manufacturing hubs or even agricultural systems, the code for monitoring zone health could greatly enhance operations, efficacy and safety. The subject innovation brings forth a significant shift in the present way of handling discrepancies in any operational system. The efficient response mechanism coupled with the proactive notification system underlines the ingenuity of this preferred embodiment, potentially reducing downtime and guaranteeing a more streamlined operational flow. Concerning usability and overall applicability, this system manages to reduce the gap between problem detection and response time, solidifying its potential in a vast number of segments.

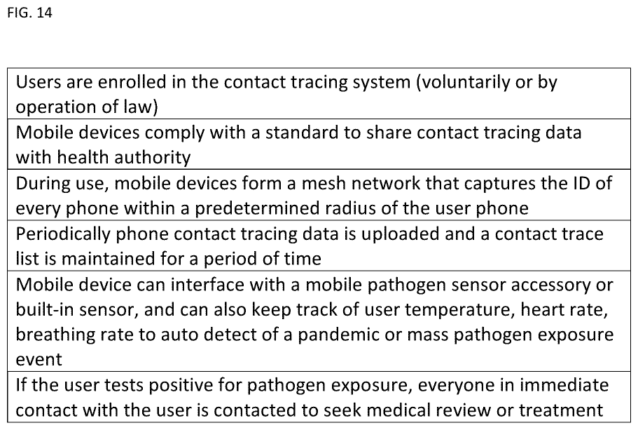

FIG. 14 shows an exemplary process for using mobile networks and data source. The system uses data from a network of mobile devices to detect the spread of a disease. The preferred embodiment relates to a digital monitoring, control, and adjustment system for air flow configuration, primarily in the realm of public spaces such as offices, retail stores, transit systems, and schools, but extends to domestic environments as well. The focus of the system is to configure and control the movement and distribution of air in response to a specific trigger, defined primarily as a COVID event or any other community health event. This system aims to reduce the spread and proliferation of airborne pathogens, thereby increasing the safety and health of individuals populating these spaces.

The system comprises a unique code for triggering the adjustment of air flow in the event of an identified community health event. This could be in the form of an influx of a contagious disease or virus, particularly COVID-19. The programming of the system is developed based on epidemiological data and models, taking into account different modes of air transmission of pathogens. It then adjusts the air circulation accordingly. For example, in the event of a Covid outbreak, the system is programmed to reconfigure the air circulation to minimize prolonged exposure of individuals to contaminated air. This advanced configuration can involve reducing air recirculation or increasing ventilation, determined based on the circumstances and type of pathogen.

In a broader sense, this preferred embodiment is a significant technological advancement for public and community health. It combines data science, epidemiology, and air engineering in a synchronized manner to contribute to mitigating the risks of airborne transmission of diseases. Additionally, it emphasizes the need and significance of having a proactive and reactive approach to tackle potential and existing health crises. It establishes the significance of using technology as a protective shield against potential health crises, thereby contributing to the security and sustainability of our communities. It does not only prevent the spread of diseases but also aids in efficiently managing the situation during an outbreak by modifying the environmental conditions. By doing so, it provides an integrated solution which is key for managing and adapting to the ongoing and future global health scenarios.

The aspect of the preferred embodiment provides a system for controlling an air management method using.machine learning. This system is embedded with a specified code designed to manage the air quality measures in various environments such as commercial spaces, industrial facilities, residential buildings, healthcare facilities, schools, among other places. Addressing the growing need for improved air quality management, this system uses machine learning algorithms to adapt and evolve based on continuously updated data. This data includes sensor-derived information, environmental parameters, and public health data.

The primary dataset for this process is gathered from sensors embedded within the system. These sensors measure various aspects like temperature, humidity, carbon dioxide levels, volatile organic compounds, particulate matter, and more. Another critical data source is the environmental data, which could include external factors like weather conditions, pollution levels, pollen counts, and more. Public health data sources contribute information on prevalent diseases, allergens, city-level pollution data, population density, and other data types related to health and wellness. The integration of these data types allows the system to create a more holistic understanding of the air quality and its impact on the occupants of the space.

The machine learning aspect of the system allows for the processing and analysis of this vast and varied data. Machine learning algorithms can detect patterns and trends, make predictions, and guide actions for the air management system. This could involve triggering certain air cleaning processes, adjusting ventilation and filtration settings, or recommending preventive measures. The machine learning models used can be regularly updated and trained with fresh data ensuring that the system remains responsive and adaptive in real-time. This preferred embodiment thereby presents a novel approach to air management that can significantly enhance indoor air quality based on comprehensive and continuously updated information.

The preferred embodiment relates to a system for managing air quality in a given space. This system comprises one or more sensors strategically positioned in the assigned space to collect varied data on air flow, energy consumption, and quality of air. These sensors work in conjunction with an air management system, engineered to optimize air quality within a predetermined space.

Positioned crucially, a processor, coded for data collection is coupled to the sensor and air management system. This processor collects air flow data, energy consumption data, and air quality data from sensors placed in the space. Additionally, it retrieves data from a community within geometric proximity or a neighborhood, processing both sets of data simultaneously.

Moreover, the processor is designed to use third-party environmental and public health data to calculate risk assessments. This data collection is fundamental to the functioning of the air quality management system as it influences the setting of parameters and the subsequent mitigation tactics employed to optimize building occupant health and the energy efficiency of a given space.

An important functionality of the processor is in controlling the air management system to manage air quality in the space. When outdoor air contamination is ascertained to be below a certain threshold, the system escalates the outdoor air exchange rate to drive out any indoor contamination. Further, if the outdoor contamination falls below another threshold, a decrease in the outdoor air fraction is effected while also raising the air exchange rate.

The system becomes increasingly complex when, if indoor contamination surpasses that of the outdoor environment, the processor raises the outdoor air exchange rate. This increase in exchange rate is controlled by adjusting the air damper positions to further allow for outdoor air flow.

Unique circumstances, such as when both indoor and outdoor contaminations are found to exceed a third threshold, the processor generates an air changes per hour (ACH) command to the air management system. Simultaneously, the processor moderates the one or more air damper positions to regulate the exchange rate in a situation where both the inside and outside air are deemed unsuitable for health.

One of the most important elements of this preferred embodiment is the integration of machine learning into the system. This allows the air management system to control parameters based on updated sensor data, environmental data, and public health data. This constant learning and adapting system drives the optimization of both energy efficiency and air quality, resulting in better health conditions for building occupants.

The preferred embodiment relates to an advanced system specifically devised to enhance the functionality, utilization, and convenience of specific spaces. These spaces can encompass various areas such as a commercial building, a floor of a building, a house, or even a single room. The system's versatility allows for customization and adaptation according to the spatial parameters in question, thereby tailoring its features to suit the demands of the designated location. Whether you are looking to optimize an expansive commercial structure or a single compartment within a home, this preferred embodiment is designed to be flexible and comprehensive to facilitate maximum utility.

The system, embedded within the starting point of any structural planning or existing structures, brings a novel perspective towards space optimization and functionality. Whether it's a vast corporate building requiring interconnected functional zones or a house demanding a personal touch in every corner, the system promises to provide solutions for a wide range of spatial needs. The system has an inherent capacity to navigate through multiple floors of a building, making it highly practical for structures of various sizes and complexities. Its unique design enables it to function efficiently in properties with multiple rooms and floors, thereby enhancing the efficiency of the entire building or house.

The structure of this preferred embodiment is such that it not only increases convenience but also provides extensive scope for personalized optimization. The sophisticated design combined with advanced technology ensures that every square foot of any space, irrespective of its designation as a commercial building, a house, or a single room is utilized to its maximum potential. The preferred embodiment recognizes the individuality of each space and provides applicable solutions in terms of layout, planning, and implementation, thereby significantly enhancing the adaptability and usability of any given space. This patented system illustrates a significant advancement in space utilization and optimization, paving the way for the future of spatial interaction and efficiency.

The preferred embodiment pertains to a system designed to provide an analytical framework for quantifying the relationship between exposure to various indoor contaminants and the health of building occupants. This preferred embodiment leverages advanced computational strategies to amass data relating to the quality of indoor air, the composition of indoor contaminants (chemical, physical, or biological), and the health status of building occupants. The incorporation of multiple sources of information, each with a distinct level of possible contamination, renders the system's predictions more accurate and comprehensive. The analysis may be augmented with data pertaining to factors like the duration of exposure, the frequency of exposure, the concentration of contaminants, etc. By providing a quantitative measure of health-risk linked with internal contamination, the preferred embodiment paves the way towards better understanding and management of the health impacts from indoor environmental quality.

To detail its operational procedures, the system collects relevant data about indoor contaminants and the health of building occupants through multiple input streams, such as sensors embedded in the building, personal health trackers for occupants, periodic health and/or environmental assessments, among others. This unique interplay of diverse data streams offers a multilayered perspective on the entire scenario, further emphasizing the robustness of the system. The collected data is then processed, analyzed, and visualized using machine learning algorithms and statistical models to identify patterns and trends, which are then expressed as a numerical quantification of risk. This system promotes proactive measures as it enables the prediction of potential health issues due to prolonged or significant exposure to identified contaminants.

The preferred embodiment promotes not just the prevention of health conditions triggered by poor indoor environmental conditions, it also drives advancements in the field of building design, maintenance and regulation. Its usage could span a wide variety of environments-residential homes, corporate offices, healthcare facilities, educational institutions, etc. As such, it has the potential to revolutionize perceptions about internal air-quality and its role in fostering a healthier living for the occupants. Furthermore, the system develops a strong foundation for the formulation of data-driven policies in environment-health sectors, and underlines the need for consistent measures to monitor and rectify indoor contamination levels. By enabling a tangible, quantifiable measure of health risk from indoor contaminants, the preferred embodiment brings a new dimension to public health strategies and architectural best practices.

The preferred embodiment relates to a revolutionary system designed to safeguard the quality of indoor air by means of devising risk-mitigation control strategies for building Heating, Ventilation, and Air Conditioning (HVAC) equipment. This system is encapsulated in a code, thus rendering this advanced system compatible and integratable with a wide variety of current and future HVAC systems. The preferred embodiment identifies, assesses, and effectively mitigates a broad range of airborne contaminants that could potentially harm the occupants' health or compromise the overall indoor air quality. The system's code is inclusive but not limited to the detection and control of contaminants such as chemicals, bacteria, allergens, viruses, fungi, and other harmful particulates.

The innovative system comprises a proprietary algorithm that is capable of performing real-time monitoring and risk assessment of the indoor environment. Once a specific degree of risk is identified, the system formulates a control strategy aimed at eliminating or reducing the identified contaminant risk. The control strategy may include recommendations for modifications to the HVAC equipment parameters, usage instructions, intervals between maintenance, anticipated maintenance requirements, or changes to the air filtration system. This combination of risk identification and risk mitigation optimizes the HVAC system's performance, ensuring cleaner, fresher, and healthier indoor air for occupants.

As a comprehensive solution, this preferred embodiment also provides a predictive system. Through an analysis of indoor air quality data over time, the system can anticipate potential changes in air quality. This predictive feature allows for preemptive measures, ensuring improved air quality and reduced risk of air contamination. Additionally, the system could inform of a possible upgrade, replacement or repair of the HVAC equipment, saving cost at an early stage. Overall, the preferred embodiment empowers users with crucial information and control over their indoor environment, making a significant contribution towards creating healthier and safer spaces.

This preferred embodiment relates primarily to a system that comprises neural network code for learning about air quality. The system relates to the field of artificial intelligence, machine learning, and environmental analytics. The primary objective of this system is to analyze and predict the intricacies of air quality that fluctuate based on various environmental and anthropogenic factors. The said neural network code implements machine learning algorithms and data processing to understand patterns in air quality. This system may be beneficial for both environmental monitoring purposes and public health, among others.

The neural network code embedded in this system enables it to learn and predict air quality based on predefined parameters such as levels of carbon monoxide, nitrogen dioxide, sulfur dioxide, ambient temperature, and humidity. The neural network being utilized can be a feed-forward network, a recurrent neural network, or any other relevant type, which can be trained on historical air quality data. It uses this data to identify patterns and correlations, thereby achieving a higher degree of accuracy in predicting future air quality conditions.

The operation of this system is designed to be user-friendly and efficient. It can either continuously analyze the air quality data in real-time or process gathered data offline. A Global Positioning System (GPS) can be embedded in the system to correlate the air quality data with the geographical location. This information can be used to create visualizations, heatmaps, and provide highly localized air quality predictions. Furthermore, the system includes an alert mechanism to inform the relevant authorities or the public about a predicted decline in air quality conditions. This new preferred embodiment holds substantial potential in revolutionizing the way we monitor and predict the environment's air quality and significantly contribute to public health safety and environmental studies.

The present system pertains to an automated energy and air quality management platform, expressly designed to provide optimized air quality while maintaining an efficient energy consumption rate. At the heart of this system is a server loaded with specially designed computer codes, primed to process a variety of data related to energy consumption and efficiency. This could include data types such as patterns of energy usage, baseline energy consumption metrics, unique energy-saving percentages, and energy efficiency parameters. The server serves as the central processing unit, from where it makes complex computations and decisions.

In a continuing feature of the present system, it is equipped with a neural network that is in constant communication with the server. The neural network has the capacity to receive and process copious amounts of data from sensors strategically placed in the space. This data predominantly revolves around air quality parameters such as the volume of airflow, the concentration of particles in the air, the presence of toxic gases, and the general quality of air within the space. The role of the neural network is critical as it makes possible the optimization of fan speeds to provide improved indoor air quality conditions. Specifically, this neural network-enabled function activates when the air quality falls below a predetermined threshold, subsequently leading to adjustments in fan speeds to enhance the quality of air.

In the event where air quality standards are satisfactory, the system, guided by the software in the server, diverts to focusing on energy efficiency. The fan can be regulated to operate at a speed that consumes minimal energy. In turn, this ensures an optimal balance between maintaining high-quality indoor air and low energy consumption is achieved. Subsequently, achieving savings in energy bills while assuring the health and comfort of the occupants in the space. Owing to its sophisticated structure and functionalities, this system provides an automated, optimized solution for air quality and energy management in various settings—from homes to commercial establishments, to even large-scale industrial units.

Various modifications and alterations of the preferred embodiment will become apparent to those skilled in the art without departing from the spirit and scope of the preferred embodiment, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the preferred embodiment have been described above, it should be understood that they have been presented by way of example only, and not of limitation. The various diagrams may depict an example architectural or other configuration for the preferred embodiment, which is done to aid in understanding the features and functionality that may be included in the preferred embodiment. The preferred embodiment is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the preferred embodiment. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the preferred embodiment is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the preferred embodiment, whether or not such embodiments are described and whether or not such features are presented as being a part of a described embodiment. Thus the breadth and scope of the preferred embodiment should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the preferred embodiment may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the preferred embodiment. Various modifications to these embodiments will be readily apparent to those skilled in the art, and the generic principles defined herein may be applied to other embodiments without departing from the spirit or scope of the preferred embodiment. Thus, the preferred embodiment is not intended to be limited to the embodiments shown herein but is to be accorded the widest scope consistent with the principles and novel features disclosed herein.

1. A system to manage air quality in a space, comprising:
a processor;
one or more sensors coupled to the processor to collect air flow data, energy consumption data, and air quality data in the space;
one or more air dampers controlled by the processor; and
code executed by the processor to periodically receive government data and neighboring buildings and apply environmental data or public health data with the data sources to calculate risk mitigation and to optimize building occupant health and energy efficiency by controlling an air management system to provide air quality in the space and if outdoor contamination is below a threshold, increasing an outdoor air exchange rate to remove indoor contamination, and when the outdoor contamination is below a second threshold, decreasing an outdoor air fraction while increasing the an air exchange rate, if when indoor contamination exceeds outdoor contamination, increasing the outdoor air exchange rate by adjusting one or more air damper positions to increase outdoor air flow, and if when the indoor and the outdoor contaminations are above a third threshold, adjusting an air changes per hour (ACH) command to the air management system and moderating the one or more air damper positions, wherein the code fuses health or safety data from government servers, climate data from weather servers, and local building data from nearby buildings, wherein the code applies one or more learning machine ensemble.

2. The system of claim 1, wherein the space, comprises a commercial building, a floor of the building, a house, or a room, further comprising using future third-party forecasted air quality conditions to predictively control air quality.

3. The system of claim 1, comprising code for quantifying relationships between exposure to indoor contaminants and the health of the building occupants.

4. The system of claim 1, comprising code for generating indoor air contaminant risk-mitigation control strategies based on data from a community in geometric proximity or a neighborhood.

5. The system of claim 1, comprising code for modeling airflow patterns for a ventilation system to determine placement of air quality sensors at predetermined air locations.

6. The system of claim 1, comprising code for assessing energy consumption with energy disaggregation of appliances in the space.

7. The system of claim 1, comprising code for maintaining a predetermined pressure in each space.

8. The system of claim 1, comprising code for adjusting Outdoor Air Fraction (OAF) and Air Change per Hour (ACH) based on Outdoor and Indoor air contaminants informed by the acceptable risk threshold and adjusting flow and ACH based on occupants and public health infection risks.

9. The system of claim 1, comprising performing edge processing of the ACH to provide real-time control with a distributed processing architecture where each building performs its own data fusion from health or safety data from government servers, climate data from weather servers, and local building data from nearby buildings.

10. The system of claim 1, wherein the ensemble, comprises mL models, Fast forest, changepoints, stochastic models, and coefficients with CDD & HDD.

11. The system of claim 1, comprising code for controlling the air management system to isolate and evacuate indoor air contaminants based on indoor air quality sensors.

12. The system of claim 1, comprising code for monitoring zone health, initiating local control commands and sending notifications via email.

13. The system of claim 1, comprising code for adjusting air flow in response to a COVID event or community health event.

14. The system of claim 1, comprising code for applying machine learning to control the air management system based on updated sensor, environmental and public health data.

15. A system to manage air quality in a space, comprising:
one or more sensors positioned in the space;
an air management system; and
a processor coupled to the one or more sensors and air management system with code for:
collecting air flow data, energy consumption data, and air quality data from one or more sensors in the space and from a community in geometric proximity or a neighborhood;
collecting third party environmental and or public health data to calculate risk assessments and apply mitigation tactics to optimize building occupant health and energy efficiency energy efficiency;
controlling an air management system to provide air quality in the space and if outdoor contamination is below a threshold, increasing an outdoor air exchange rate to remove indoor contamination, and if outdoor contamination is below a second threshold, decreasing an outdoor air fraction while increasing the air exchange rate, if indoor contamination exceeds outdoor contamination, increasing the outdoor air exchange rate by adjusting one or more air damper positions to increase outdoor air flow, and if indoor and outdoor contaminations are above a third threshold, adjusting an air changes per hour (ACH) command to the air management system and moderating the one or more air damper positions;
applying machine learning to control the air management system based on updated sensor, environmental and public health data.

16. The system of claim 15, wherein the space, comprises a commercial building, a floor of the building, a house, or a room.

17. The system of claim 15, comprising code for quantifying relationships between exposure to indoor contaminants and the health of the building occupants.

18. The system of claim 15, comprising code for generating indoor air contaminant risk-mitigation control strategies for building HVAC equipment.

19. The system of claim 15, comprising neural network code for learning about air quality.

20. The system of claim 19, comprising a server with code for processing energy consumption or efficiency data, wherein the neural network receives airflow data from sensors in the space, and optimizes fan speed for air quality when the air quality is below a threshold, and otherwise manages the fan for energy efficiency.
